(19) United States
(12) Patent Application Publication
(10) Pub. No.: US 2005/0014020 A1
(43) Pub. Date: Jan. 20, 2005

(54) Organic electroluminescent device

(76) Inventors: Hirohito Yoneyama, Minamiashigara-shi (JP); Mieko Seki, Minamiashigara-shi (JP); Masahiro Iwasaki, Minamiashigara-shi (JP); Katsumi Nukada, Minamiashigara-shi (JP); Daisuke Okuda, Minamiashigara-shi (JP); Hidekazu Hirose, Minamiashigara-shi (JP); Tadayoshi Ozaki, Minamiashigara-shi (JP); Hiroaki Moriyama, Minamiashigara-shi (JP); Toru Ishii, Minamiashigara-shi (JP); Takeshi Agata, Minamiashigara-shi (JP); Kiyokazu Mashimo, Minamiashigara-shi (JP); Katsuhiro Sato, Minamiashigara-shi (JP)

Correspondence Address: FILDES & OUTLAND, P.C., 20916 MACK AVENUE, SUITE 2, GROSSE POINTE WOODS, MI, 48236, US

(21) Appl. No.: 10/783,847

(22) Filed: Feb. 20, 2004

(30) Foreign Application Priority Data
Jul. 18, 2003 (JP) 2003-276570

(51) Int. Cl. H05B 33/12

(52) U.S. Cl. 428/690; 428/917; 313/504; 313/506

(57) ABSTRACT

The present invention provides an organic electroluminescent device including a pair of electrodes including an anode and a cathode, at least one of which is transparent or translucent; and one or more organic compound layers placed between the pair of electrodes, wherein at least one of the organic compound layers contains a charge transport material that satisfies the following relations:
(tₐ−t_{T})/tₐ<0.5 Expression (1)
D/μ<20 Expression (2)
wherein, in an electric field of 10 V/μm, t_{T} is a transit time of a transient photocurrent waveform; I_{T} is a current value at time t_{T}; Iₐ is half of the current value I_{T}; tₐ is a time at the current value Iₐ on the transient photocurrent waveform; D and μ are respectively a diffusion coefficient and a true mobility obtained from the transient photocurrent waveform; and D/μ is the ratio of D to μ.

### CROSS-REFERENCE TO RELATED APPLICATIONS

This application claims priority under 335 U.S.C.119 from Japanese Patent Application No. 2003-276570, the disclosure of which is incorporated by reference herein.

### BACKGROUND OF THE INVENTION

1. Field of the Invention

The present invention relates to an organic electroluminescent device and specifically to a longer-life organic electroluminescent device.

2. Description of the Related Art

Electroluminescent devices (hereinafter, also referred to as “EL devices”), which are a spontaneous-luminescent whole solid state device, have high visibility and high impact resistance, and therefore are expected to find wide applications. Conventionally, the predominant EL device has used an inorganic fluorescent material, for example, which is generally a II-VI compound semiconductor of an inorganic material such as ZnS, CaS or SrS doped with a rare earth element for a luminescence center such as Mn, Eu, Ce, Tb, or Sn. An EL device produced from such an inorganic material requires an AC driving voltage of 200 V or higher and therefore has problems such as a high manufacturing cost, difficulty in forming a full color device and insufficient brightness.

Recently, Tang et al. invented an EL device that includes two very thin vacuum-deposited layers (a charge transport layer and a light emitting layer) between an anode and a cathode and that can achieve high brightness under low driving voltage (for example, see Appl. Phys. Lett. 51, 913, 1987). Since then, such a layered type organic EL device has been actively investigated. Also, three-layered EL devices in which the charge transport function is separated from the light emitting function have been reported. Such a three-layered structure can ease restrictions on the charge transport function and have increased flexibility in selecting light emitting layer dyes, which determine the color of the emitted light. It is also suggested that in such a three-layered structure, holes and electrons (or excitons) can effectively be trapped in the central light emitting layer to produce increased emission.

As a result of such research and development, organic EL devices are provided which can emit light under a low DC voltage of several to several tens of volts and in which different types of the fluorescent organic compounds can produce different colors (such as red, blue and green) of emission.

Further, use of a starburst amine as a hole transport material to produce a stable amorphous glass state for the purpose of solving the problem with thermal stability of the EL device has been reported (for example, see Proceedings of the 40th Meeting of the Japan Society of Applied Physics, 30a-SZK-14, 1993). Use of a polymer having a triphenylamine-introduced polyphosphazene side chain has also been reported (for example, see Proceedings of the 42nd Symposium on Macromolecules 20J21, 1993).

On the other hand, research and development has also been conducted on a monolayer type EL device. According to reports, such a device uses an electrically conductive polymer such as poly(p-phenylenevinylene) (for example, see Nature, Vol. 357, 477, 1992). Also proposed is a device including hole transport polyvinylcarbazole in which an electron transport material and a fluorescent dye are mixed (for example, see Proceedings of the 38th Meeting of the Japan Society of Applied Physics, 31p-G-12, 1991).

The organic EL devices with the above characteristics are expected to find applications in various types of light-emitting devices, display devices and the like.

A long life is one of the major objects in the application of the organic EL device in the field of flat panel displays. A long-life device is important, because a long-duration emission has conventionally been accompanied by the spread of a non-luminescent region (dark spot), a cause of which is a deterioration of the organic EL layer in the organic EL device.

Thus, there is a demand for a long-life organic EL device.

### SUMMARY OF THE INVENTION

The present invention provides an organic electroluminescent device including: a pair of electrodes including an anode and a cathode, at least one of which is transparent or translucent; and one or more organic compound layers placed between the pair of electrodes, wherein at least one of the organic compound layers contains a charge transport material that satisfies the following relations:
(tₐ−t_{T})/tₐ<0.5 Expression (1)
D/μ<20 Expression (2)
wherein, in an electric field of 10 V/μm, t_{T} is a transit time of a transient photocurrent waveform; I_{T} is a current value at time t_{T}; Iₐ is half of the current value I_{T}; tₐ is a time at the current value Iₐ on the transient photocurrent waveform; D and μ are respectively a diffusion coefficient and a true mobility obtained from the transient photocurrent waveform; and D/μ is the ratio of D to μ.

### BRIEF DESCRIPTION OF THE DRAWINGS

Preferred embodiments of the invention will be described in detail based on the following figures, wherein:

FIG. 1 is a schematic cross section of an example of the inventive organic EL device; FIG. 2 is a schematic cross section of another example of the inventive organic EL device;

FIG. 3 is a schematic cross section of a still another example of the inventive organic EL device.

### DETAILED DESCRIPTION OF THE INVENTION

An organic EL device of the present invention is described in detail below.

The inventive organic EL device comprises: a pair of electrodes including an anode and a cathode, at least one of which is transparent or translucent; and one or more organic compound layers placed between the pair of electrodes, wherein at least one of the organic compound layers contains a charge transport material that satisfies the following relations:
(tₐ−t_{T})/tₐ<0.5 Expression (1)
D/μ<20 Expression (2)
wherein, in an electric field of 10 V/μm, t_{T} is a transit time of a transient photocurrent waveform; I_{T} is a current value at time t_{T}; Iₐ is half of the current value I_{T}; tₐ is a time at the current value Iₐ on the transient photocurrent waveform; D and μ are respectively a diffusion coefficient and a true mobility obtained from the transient photocurrent waveform; and D/μ is the ratio of D to μ.

In the organic EL device, the charge transport material has functions of receiving charges from the substrate or the charge injecting layer when a voltage is applied to the device and supplying the charges to the luminescent material without leaving any residual charge in the charge transport layer. If the residual charges accumulate in the charge transport layer, the device would have a short life.

The inventors have made investigations and found that the charge transport material that satisfies Expressions (1) and (2) in an electric field of 10 V/μm can prevent accumulation of the charge in the organic EL device and can form a long-life organic EL device.

If the charge transport material for the organic EL device does not satisfy Expression (1) or (2), the charge transport material-containing layer may have many charge traps. The charge traps may be an energy-related trap, a structure-related trap or the like, and any type of the traps causes charge accumulation. In particular, an organic EL device made of a material which tends to cause charge accumulation has a significantly reduced life, because a large current flows in the device in operation.

In an electric field of 10 V/μm, the charge transport material for use in the inventive organic EL device preferably exhibits a (tₐ−t_{T})/tₐ value of 0.4 or less, more preferably 0.3 or less, and still more preferably 0.2 or less. If the (tₐ−t_{T})/tₐ value is 0.4 or less, the organic EL device can have a longer life.

In an electric field of 10 V/μm, the charge transport material for use in the inventive organic EL device preferably exhibits a D/μ value of 15 or less, more preferably 10 or less, and still more preferably 5 or less. If the D/μ value is 15 or less, the organic EL device can have a longer life.

In the invention, the transient photocurrent waveform is obtained by using the Time of Flight method (hereinafter, also referred to as the TOF method), which is generally used in evaluation of organic transport materials.

In the invention, whether the charge transport material satisfies Expressions (1) and (2) or not is determined based on a transient photocurrent waveform, which is obtained by a process including of forming a 6 μm thick film of the charge transport material on ITO provided on a glass substrate, providing the substrate having the film with a gold counter electrode, using the substrate with the film and the gold counter electrode as a measurement sample, and measuring the transient photocurrent waveform at 17° C. by the TOF method.

Any charge transport material for the organic electroluminescent device according to the invention that satisfies Expressions (1) and (2) in an electric of 10 V/μm may be used without limitation. In the organic electroluminescent device, the charge transport material may be used as a hole or electron transport material.

In the invention, the charge transport material may be a polymer charge transport material, which preferably has a weight average molecular weight (Mw) of 10000 or more, more preferably 30000 or more, and still more preferably 40000 or more.

A too low weight average molecular weight of the polymer charge transport material may result in poor film-forming property and therefore may cause dark spots in the organic EL device. In contrast, if the weight average molecular weight is 30000 or more, the film-forming property can be good and the cause of dark spots can be eliminated.

The polymer charge transport material preferably has a repeating unit that includes a partial structure represented by either one of the following Formulae (I-1) and (I-2). Such a polymer charge transport material can provide excellent characteristics for the organic EL device.

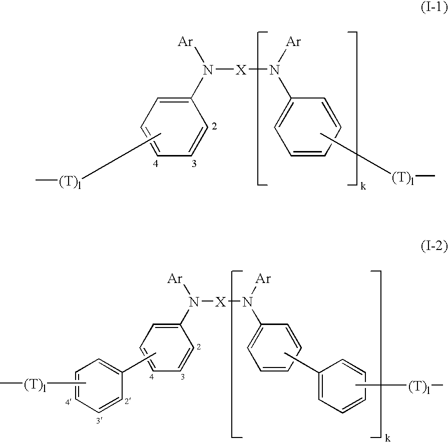

In Formulae (I-1) and (I-2), Ar represents a substituted or unsubstituted phenyl group, a substituted or unsubstituted monovalent polynuclear aromatic ring group having 2 to 10 aromatic rings, or a substituted or unsubstituted monovalent condensed aromatic ring group having 2 to 10 aromatic rings, X represents a substituted or unsubstituted bivalent aromatic group, k and 1 each independently represent 0 or 1, and T represents a linear or branched bivalent hydrocarbon group having 1 to 10 carbon atoms.

A single type or two or more types of the structures represented by Formulae (I-1) and (I-2) may be contained in the polymer charge transport material. More specifically, a single type or two or more types of the structures represented by Formula (I-1) or (I-2) may be contained in the polymer charge transport material; or a single type or two or more types of the structures of Formula (I-1) and a single type or two or more types of the structures of Formula (I-2) may be contained in the polymer charge transport material.

In Formula (I-1) or (I-2), the polynuclear aromatic ring group has a structure having two or more independent aromatic rings. Examples of the polynuclear aromatic ring group include biphenyl, terphenyl and tetraphenyl.

In Formula (I-1) or (I-2), the condensed aromatic ring group has two or more aromatic ring structures which share two or more atoms. Examples of the condensed aromatic ring group include a naphthyl group, an anthracene group, a phenanthroline group, a pyrene group, a benzophenanthroline group, a perylene group, a pentaphenylene group, and a pentacene group.

In Formula (I-1) or (I-2), the phenyl group, the polynuclear aromatic ring group, or the condensed aromatic ring group may have a substituent(s). Examples of the substituent include a hydrogen atom, an alkyl group, an alkoxy group, a substituted or unsubstituted aryl group, a substituted or unsubstituted aralkyl group, a substituted amino group, and a halogen atom.

The alkyl group preferably has 1 to 10 carbon atoms, and examples of the alkyl group include a methyl group, an ethyl group, a propyl group, and an isopropyl group.

The alkoxyl group preferably has 1 to 10 carbon atoms, and examples of the alkoxyl group include a methoxy group, an ethoxy group, a propoxy group, and an isopropoxy group.

The aryl group preferably has 6 to 20 carbon atoms, and examples of the aryl group include a phenyl group and a toluyl group.

The aralkyl group preferably has 7 to 20 carbon atoms, and examples of the aralkyl group include a benzyl group and a phenethyl group.

Examples of the substituent on the substituted amino group include an alkyl group, anaryl group, and an aralkyl group, and specific examples thereof include those listed above.

Examples of the substituent on the substituted aryl or aralkyl group include a hydrogen atom, an alkyl group, an alkoxy group, a substituted amino group, and a halogen atom.

In Formula (I-1) or (I-2), X may be any substituted or unsubstituted bivalent aromatic group and preferably selected from the groups represented by the following Formulae (1) to (7).

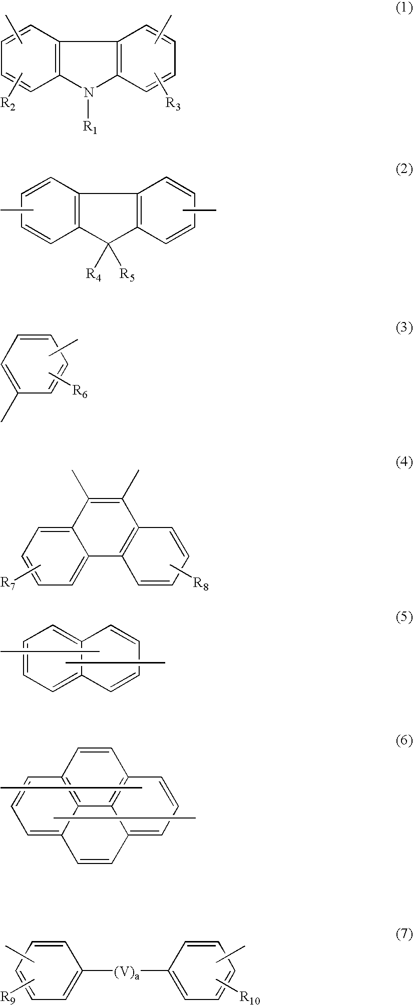

In Formulae (1) to (7), R₁ represents a hydrogen atom, an alkyl group having 1 to 4 carbon atoms, a substituted or unsubstituted phenyl group, or a substituted or unsubstituted aralkyl group; R₂ to R₁₀ each independently represent a hydrogen atom, an alkyl group having 1 to 4 carbon atoms, an alkoxyl group having 1 to 4 carbon atoms, a substituted or unsubstituted phenyl group, a substituted or unsubstituted aralkyl group, or ahalogen atom; a represents 0 or 1; and V represents one selected from the groups represented by the following Formulae (8) to (17).

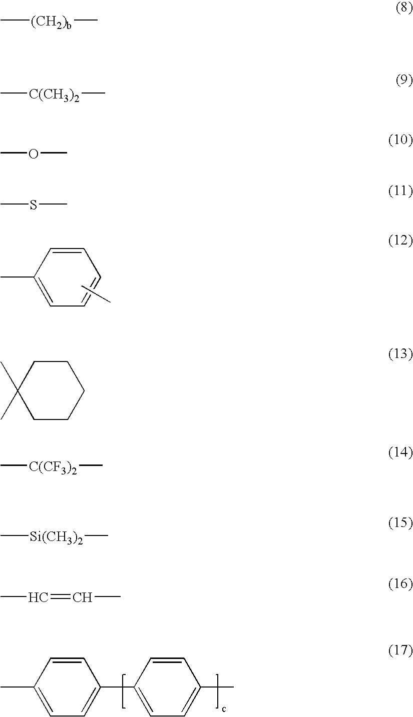

In Formulae (8) to (17), b represents an integer of 1 to 10; and c represents an integer of 1 to 3.

X preferably has any one structure of Formulae (1) to (7), more preferably any one of Formulae (1), (2), (5), and (7), and still more preferably the structure of Formula (7).

In Formula (7), V is preferably any one of Formulae (8) to (13) and (17), more preferably any one of Formulae (8), (9) and (17), and still more preferably Formula (17).

In Formula (I-1) or (I-2), k and 1 is each preferably 1.

In Formula (I-1) or (I-2), T is preferably one selected from the group consisting of a bivalent straight chain hydrocarbon group having 2 to 6 carbon atoms and a bivalent branched chain hydrocarbon group having 3 to 7 carbon atoms. Preferred examples of T are shown below.

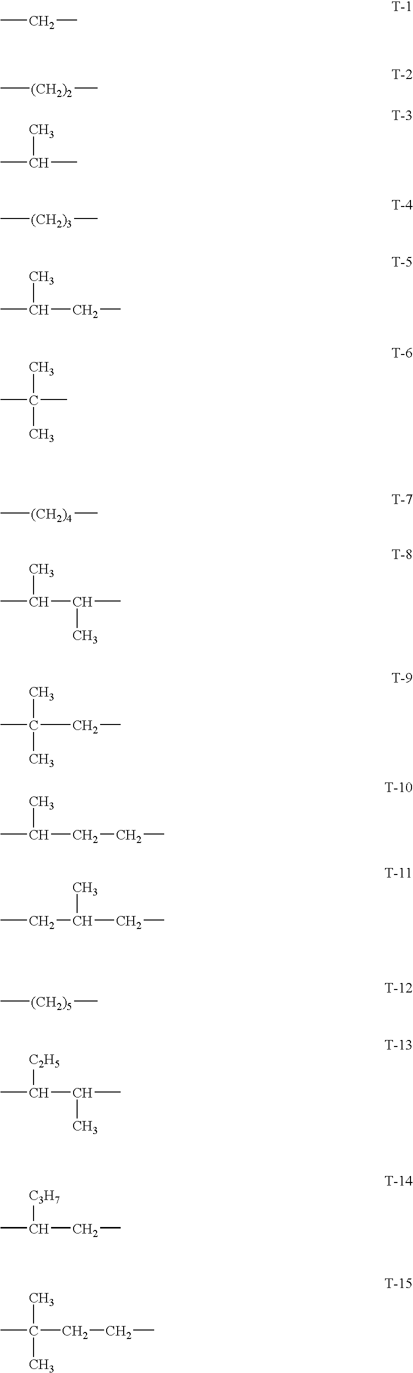

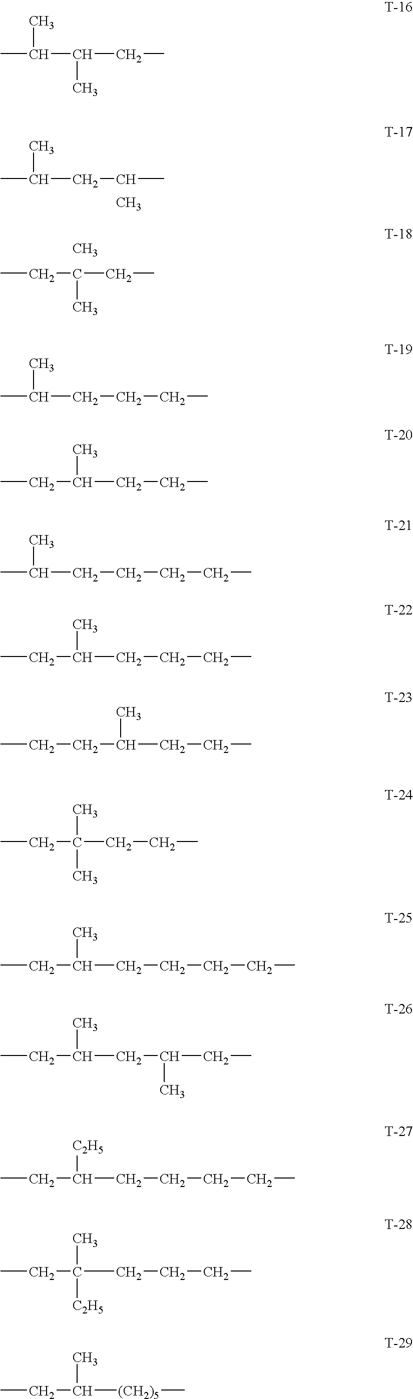

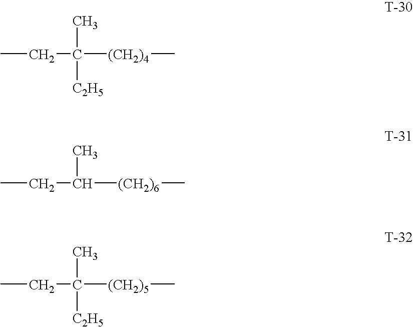

Of the above Formulae for (T), (T-1) to (T-20) are preferred; (T-1), (T-2), (T-4), (T-7) and (T-12) are more preferred; and (T-1), (T-2) and (T-4) are particularly preferred.

The polymer charge transport material is preferably represented by one selected from the group consisting of the following Formulae (II), (III), (IV) and (V).

The polymer charge transport material represented by any one of Formulae (II), (III), (IV), and (V) may be a charge transport polyester resin or polycarbonate resin.
CO-A-CO—O—(Y—O)ₘ—ₚ (II)
CO-A-CO—O—(Y—O)ₘ—CO-Z-CO—O—(Y—O)ₘ—ₚ (III)
O-A-O—CO—(B—CO)ₙ—ₚ (IV)
CO-A-CO—O—(Y—O)ₘ—ₚ CO-Z-CO—O—(Y—O)ₘ—ᵣ (V)

In Formulae (II), (III), (IV), and (V), A represents Formula (I-1) or (I-2); B represents —O—(Y′—O)ₘ,— or Z′; Y, Y′, Z, and Z′ each independently represent a bivalent hydrocarbon group; m and m′ each independently represent an integer of 1 to 5; n represents 0 or 1; p represents an integer of 5 to 5000; q represents an integer of 1 to 5000; and r represents an integer of 1 to 3500.

Y, Y′, Z, and Z′ may each independently represent any bivalent hydrocarbon group and are each specifically any one of the following Formulae (18) to (24).

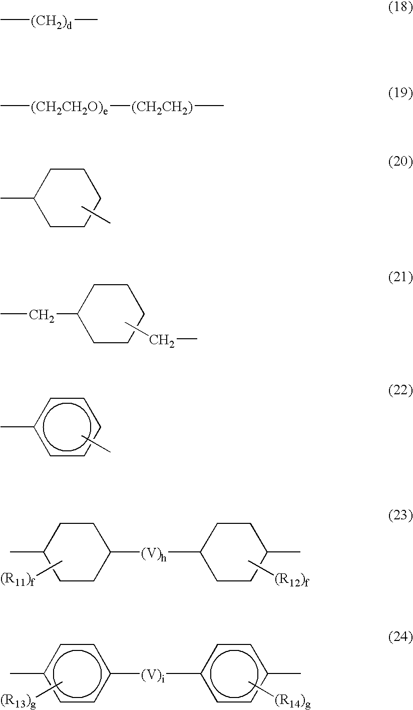

Here, R₁₁ to R₁₄ each independently represent a hydrogen atom, an alkyl group having 1 to 4 carbon atoms, an alkoxy group having 1 to 4 carbon atoms, a substituted or unsubstituted phenyl group, a substituted or unsubstituted aralkyl group, or a halogen atom; d and e each independently represent an integer of 1 to 10; f and g each independently represent 0, 1 or 2; and h and i each independently represent 0 or 1.

In Formulae (23) and (24), V is defined above.

In particular, Y, Y′, Z, and Z′ are each preferably Formula (18).

In Formulae (II), (III), (IV), and (V), m and m′ are each preferably 1 to 2; n is preferably 1; p is preferably 5 to 500; q is preferably 5 to 500; and r is preferably 1 to 500.

Specific examples of the structure represented by Formula (I-1) or (I-2) are shown below, but such examples are not intended to limit the scope of the invention. Tables 1 to 8 each show some examples of the Formula (I-1) structure, and Tables 9 to 14 each show some examples of the Formula (I-2) structure.

TABLE 1

| *1 | X | Ar | *2 | k | T |
|---|---|---|---|---|---|
| 1-1 | 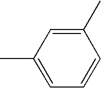 | 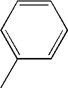 | 3 | 0 | T-2 |
| 1-2 | 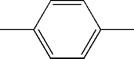 | 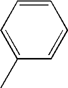 | 3 | 0 | T-2 |
| 1-3 | 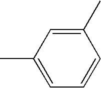 | 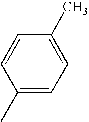 | 3 | 0 | T-2 |
| 1-4 | 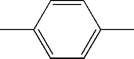 | 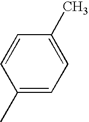 | 4 | 0 | T-2 |
| 1-5 | 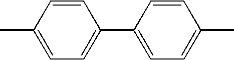 | 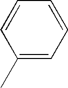 | 3 | 1 | — |
| 1-6 | 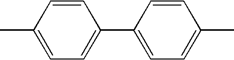 | 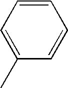 | 3 | 1 | T-2 |
| 1-7 | 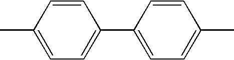 | 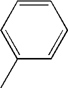 | 3 | 1 | T-5 |

TABLE 2

| *1 | X | Ar | *2 | k | T |
|---|---|---|---|---|---|
| 1-8 | 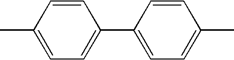 | 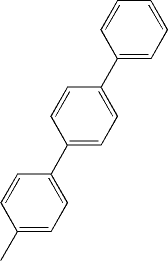 | 3 | 1 | T-2 |
| 1-9 | 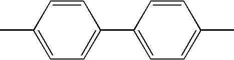 | 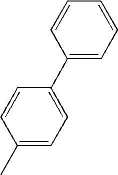 | 3 | 1 | T-2 |
| 1-10 | 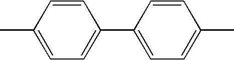 | 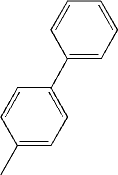 | 3 | 1 | T-8 |
| 1-11 | 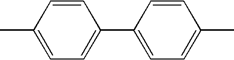 | 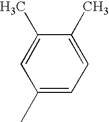 | 3 | 1 | T25 |
| 1-12 | 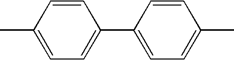 | 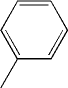 | 4 | 1 | T-5 |
| 1-13 | 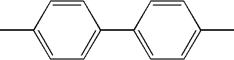 | 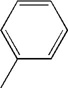 | 4 | 1 | T-1 |
| 1-14 | 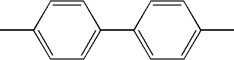 | 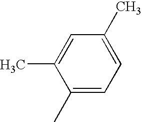 | 4 | 1 | T-2 |

TABLE 3

| *1 | X | Ar | *2 | k | T |
|---|---|---|---|---|---|
| 1-15 | 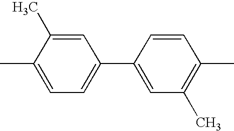 | 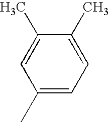 | 3 | 1 | — |
| 1-16 | 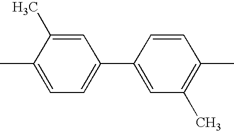 | 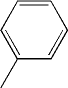 | 3 | 1 | T-2 |
| 1-17 | 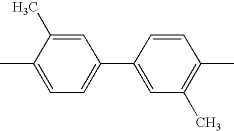 | 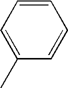 | 4 | 1 | T-2 |
| 1-18 | 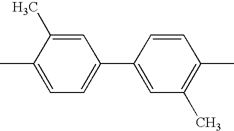 | 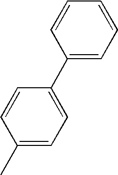 | 3 | 1 | T-1 |
| 1-19 | 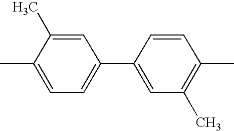 | 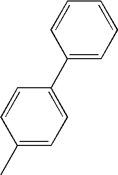 | 3 | 1 | T-2 |
| 1-20 | 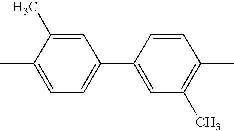 | 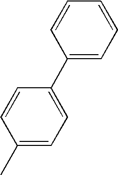 | 4 | 1 | T-4 |
| 1-21 | 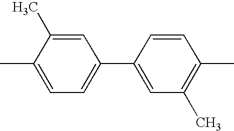 | 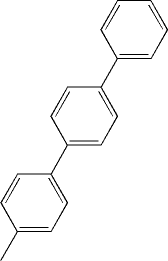 | 3 | 1 | T-2 |

TABLE 4

| *1 | X | Ar | *2 | k | T |
|---|---|---|---|---|---|
| 1-22 | 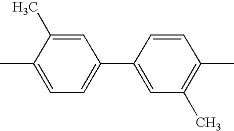 | 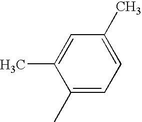 | 3 | 1 | T-2 |
| 1-23 | 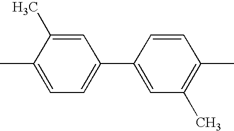 | 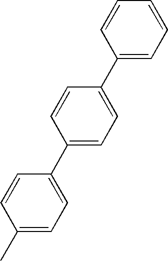 | 3 | 1 | T-13 |
| 1-24 | 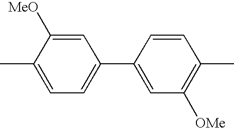 | 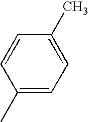 | 3 | 1 | — |
| 1-25 | 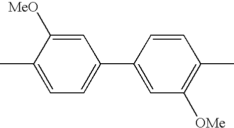 | 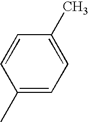 | 3 | 1 | T-2 |
| 1-26 | 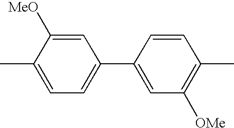 | 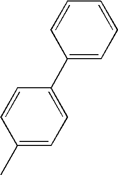 | 3 | 1 | T-2 |
| 1-27 | 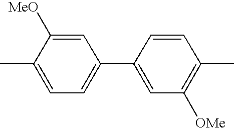 | 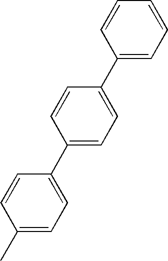 | 3 | 1 | T-2 |
| 1-28 | 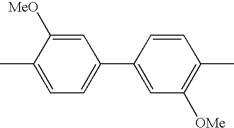 | 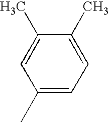 | 3 | 1 | T-8 |

TABLE 5

| *1 | X | Ar | *2 | k | T |
|---|---|---|---|---|---|
| 1-29 | 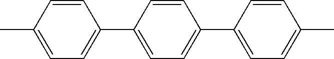 | 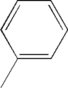 | 3 | 1 | T-2 |
| 1-30 | 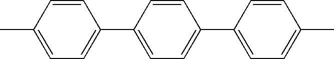 | 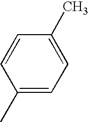 | 3 | 1 | T-2 |
| 1-31 | 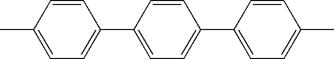 | 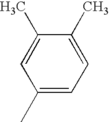 | 3 | 1 | T-2 |
| 1-32 | 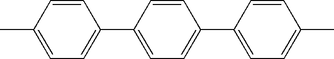 | 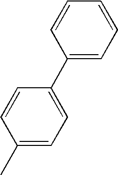 | 3 | 1 | T-2 |
| 1-33 | 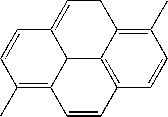 | 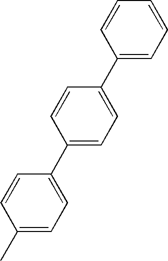 | 3 | 1 | T-2 |
| 1-34 | 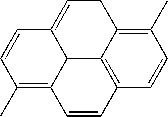 | 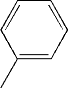 | 3 | 1 | T-8 |
| 1-35 | 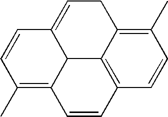 | 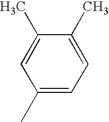 | 3 | 1 | T-18 |

TABLE 6

| *1 | X | Ar | *2 | k | T |
|---|---|---|---|---|---|
| 1-36 | 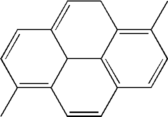 | 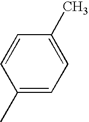 | 4 | 1 | T-20 |
| 1-37 | 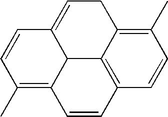 | 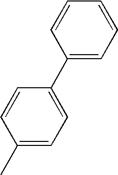 | 4 | 1 | T-24 |
| 1-38 | 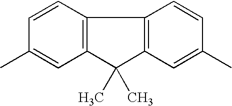 | 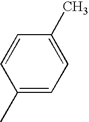 | 3 | 1 | T-2 |
| 1-39 | 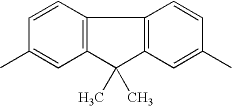 | 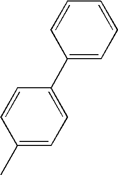 | 3 | 1 | T-8 |
| 1-40 | 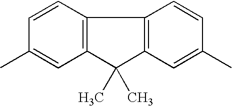 | 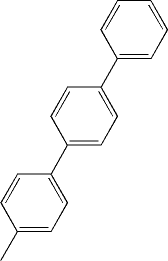 | 3 | 1 | T-18 |
| 1-41 | 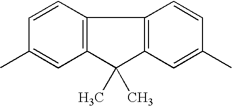 | 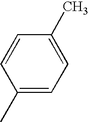 | 4 | 1 | T-20 |
| 1-42 | 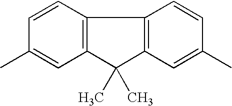 | 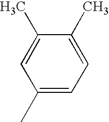 | 4 | 1 | T-24 |

TABLE 7

| *1 | X | Ar | *2 | k | T |
|---|---|---|---|---|---|
| 1-43 | 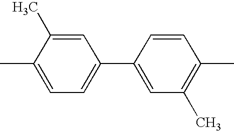 | 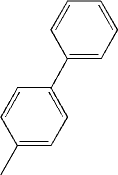 | 4 | 1 | — |
| 1-44 | 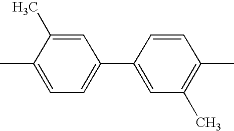 | 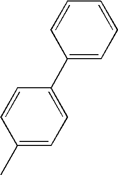 | 4 | 1 | T-1 |
| 1-45 | 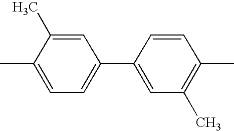 | 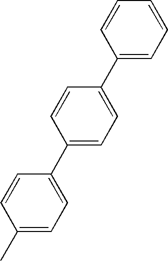 | 4 | 1 | T-2 |
| 1-46 | 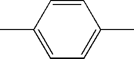 | 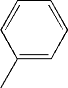 | 4 | 0 | — |
| 1-47 | 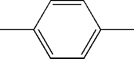 | 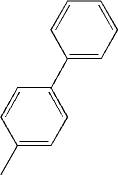 | 4 | 0 | T-1 |
| 1-48 | 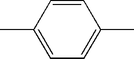 | 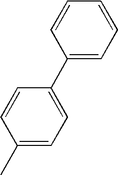 | 4 | 0 | T-2 |
| 1-49 | 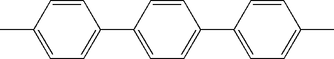 | 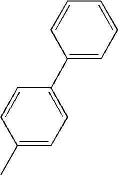 | 4 | 1 | — |

TABLE 8

| *1 | X | Ar | *2 | k | T |
|---|---|---|---|---|---|
| 1-50 | 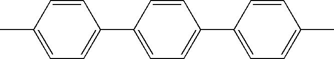 | 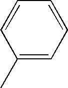 | 4 | 1 | — |
| 1-51 | 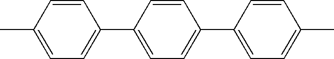 | 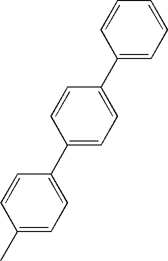 | 4 | 1 | — |
| 1-52 | 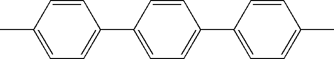 | 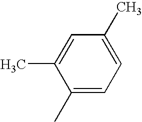 | 4 | 1 | — |
| 1-53 | 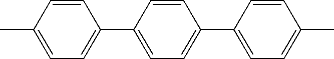 | 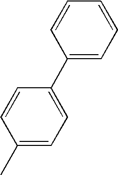 | 4 | 1 | T-2 |
| 1-54 | 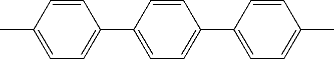 | 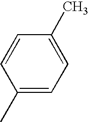 | 3 | 1 | T-18 |
| 1-55 | 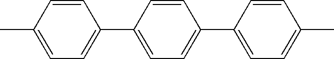 | 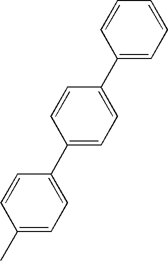 | 4 | 1 | T-20 |
| 1-56 | 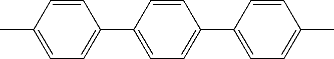 | 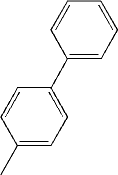 | 4 | 1 | T-24 |

TABLE 9

| *1 | X | Ar | *2 | k | T |
|---|---|---|---|---|---|
| 2-1 | 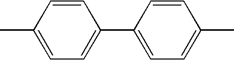 | 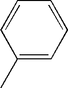 | 4,4′ | 0 | T-1 |
| 2-2 | 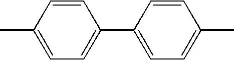 | 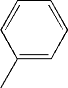 | 4,4′ | 0 | T-2 |
| 2-3 | 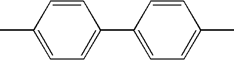 | 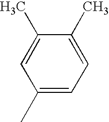 | 4,4′ | 0 | — |
| 2-4 | 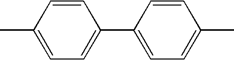 | 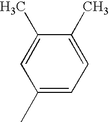 | 4,4′ | 0 | T-2 |
| 2-5 | 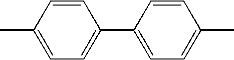 | 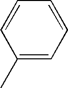 | 4,4′ | 1 | T-1 |
| 2-6 | 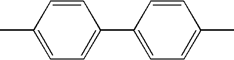 | 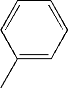 | 4,4′ | 1 | T-2 |
| 2-7 | 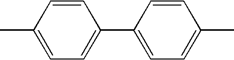 | 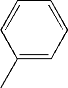 | 4,4′ | 1 | T-5 |

TABLE 10

| *1 | X | Ar | *2 | k | T |
|---|---|---|---|---|---|
| 2-8 | 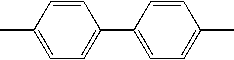 | 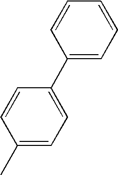 | 4,4′ | 1 | T-2 |
| 2-9 | 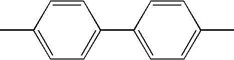 | 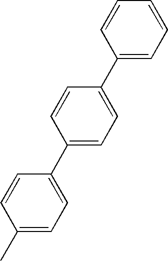 | 4,4′ | 1 | T-2 |
| 2-10 | 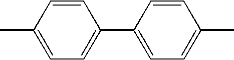 | 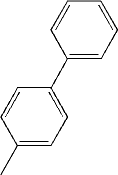 | 4,4′ | 1 | T-8 |
| 2-11 | 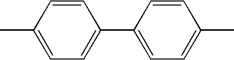 | 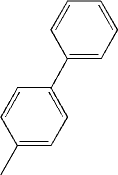 | 4,4′ | 1 | T-25 |
| 2-12 | 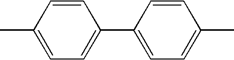 | 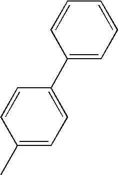 | 4,4′ | 1 | T-5 |
| 2-13 | 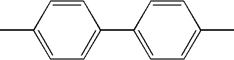 | 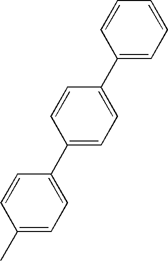 | 4,4′ | 1 | T-1 |
| 2-14 | 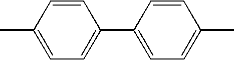 | 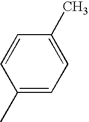 | 4,4′ | 1 | T-2 |

TABLE 11

| *1 | X | Ar | *2 | k | T |
|---|---|---|---|---|---|
| 2-15 | 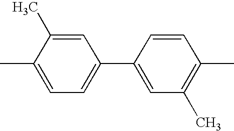 | 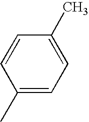 | 4,4′ | 1 | — |
| 2-16 | 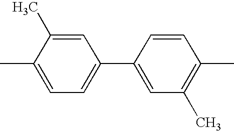 | 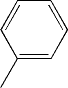 | 4,4′ | 1 | T-2 |
| 2-17 | 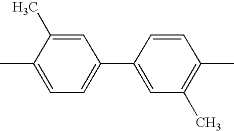 | 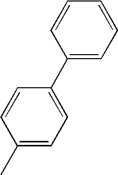 | 4,4′ | 1 | T-2 |
| 2-18 | 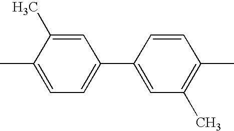 | 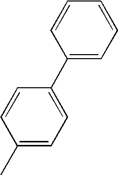 | 4,4′ | 1 | T-1 |
| 2-19 | 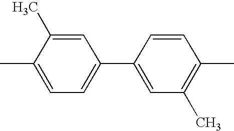 | 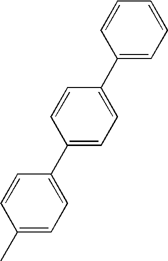 | 4,4′ | 1 | T-2 |
| 2-20 | 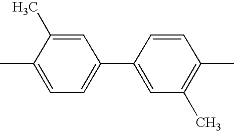 | 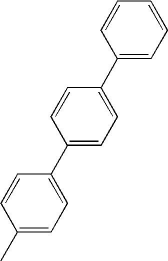 | 4,4′ | 1 | T-4 |
| 2-21 | 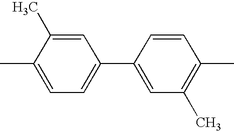 | 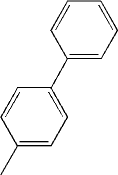 | 4,4′ | 1 | T-5 |

TABLE 12

| *1 | X | Ar | *2 | k | T |
|---|---|---|---|---|---|
| 2-22 | 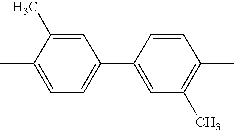 | 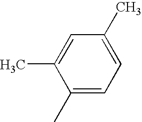 | 4,4′ | 1 | T-5 |
| 2-23 | 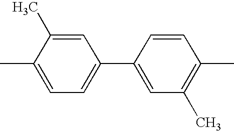 | 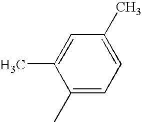 | 4,4′ | 1 | T-13 |
| 2-24 | 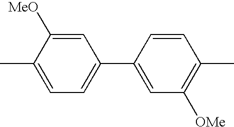 | 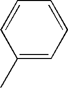 | 4,4′ | 1 | — |
| 2-25 | 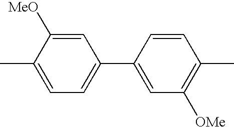 | 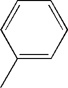 | 4,4′ | 1 | T-2 |
| 2-26 | 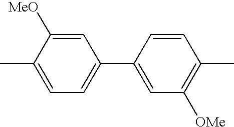 | 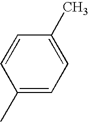 | 4,4′ | 1 | T-2 |
| 2-27 | 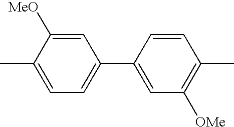 | 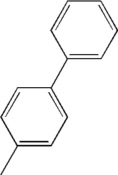 | 4,4′ | 1 | T-2 |
| 2-28 | 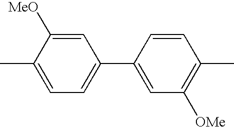 | 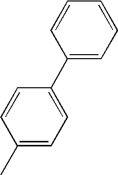 | 4,4′ | 1 | T-8 |

TABLE 13

| *1 | X | Ar | *2 | k | T |
|---|---|---|---|---|---|
| 2-29 | 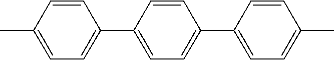 | 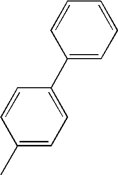 | 4,4′ | 1 | T-2 |
| 2-30 | 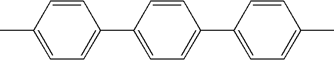 | 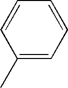 | 4,4′ | 1 | T-2 |
| 2-31 | 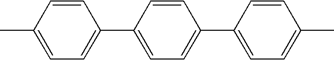 | 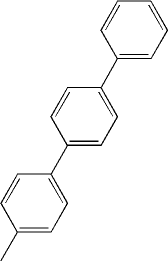 | 4,4′ | 1 | T-2 |
| 2-32 | 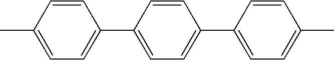 | 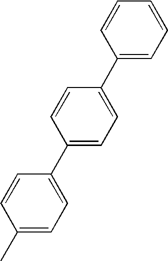 | 4,4′ | 1 | T-5 |
| 2-33 | 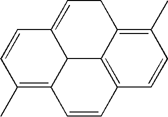 | 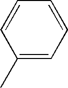 | 4,4′ | 1 | T-2 |
| 2-34 | 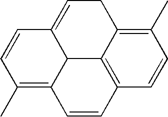 | 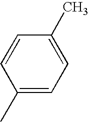 | 4,4′ | 1 | T-8 |
| 2-35 | 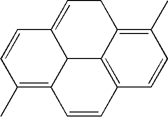 | 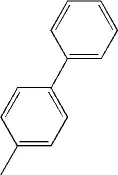 | 4,4′ | 1 | T-18 |

TABLE 14

| *1 | X | Ar | *2 | k | T |
|---|---|---|---|---|---|
| 2-36 | 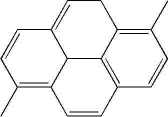 | 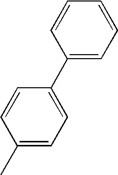 | 4,4′ | 1 | T-20 |
| 2-37 | 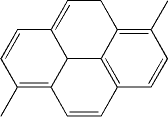 | 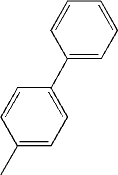 | 4,4′ | 1 | T-24 |
| 2-38 | 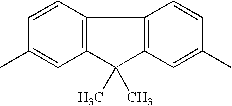 | 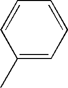 | 4,4′ | 1 | T-2 |
| 2-39 | 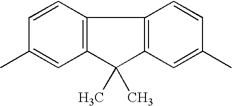 | 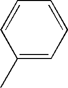 | 4,4′ | 1 | T-8 |
| 2-40 | 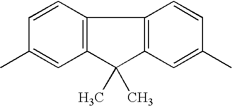 | 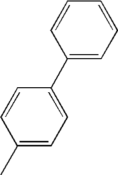 | 4,4′ | 1 | T-18 |
| 2-41 | 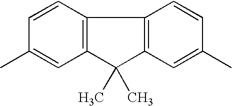 | 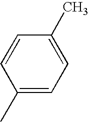 | 4,4′ | 1 | T-20 |
| 2-42 | 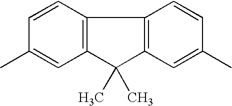 | 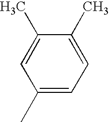 | 4,4′ | 1 | T-24 |

Remarks
*1 partial structure
*2 bond position

Specific examples of the charge transport polyester or charge transport polycarbonate resin represented by Formula (II), (III), (IV), or (V) are shown below, but such examples are not intended to limit the scope of the invention. Table 15 shows examples of the Formula (II) structure, Table 16 shows examples of the Formula (III) structure, Table 17 shown examples of the Formula (IV) structure, and Tables 18 to 23 show examples of the Formula (V) structure, respectively.

TABLE 15

| | Partial Structure | | | | |
|---|---|---|---|---|---|
| Compound | Structure | Ratio | Y | m | p |
| CTP-1 | 1-6 | — | —CH₂CH₂— | 1 | 50 |
| CTP-2 | 1-6 | — | —CH₂CH₂— | 2 | 70 |
| CTP-3 | 1-6 | — | 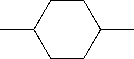 | 1 | 50 |
| CTP-4 | 1-6 | — | 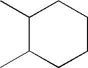 | 1 | 60 |
| CTP-5 | 1-6 | — | 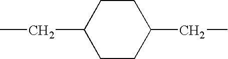 | 1 | 30 |
| CTP-6 | 1-8 | — | —CH₂CH₂— | 1 | 70 |
| CTP-7 | 1-9 | — | —CH₂CH₂— | 1 | 60 |
| CTP-8 | 1-14 | — | —CH₂CH₂— | 1 | 50 |
| CTP-9 | 1-16 | — | —CH₂CH₂— | 1 | 70 |
| CTP-10 | 1-21 | — | —CH₂CH₂— | 2 | 70 |
| CTP-11 | 1-21 | — | —CH₂CH₂— | 1 | 60 |
| CTP-12 | 2-6 | — | —CH₂CH₂— | 1 | 50 |
| CTP-13 | 2-8 | — | —CH₂CH₂— | 1 | 80 |
| CTP-14 | 2-9 | — | —CH₂CH₂— | 1 | 50 |
| CTP-15 | 2-14 | — | —CH₂CH₂— | 1 | 80 |
| CTP-16 | 2-16 | — | —CH₂CH₂— | 1 | 90 |
| CTP-17 | 2-17 | — | —CH₂CH₂— | 1 | 60 |
| CTP-18 | 1-6/1-14 | 1/1 | —CH₂CH₂— | 1 | 50 |
| CTP-19 | 1-6/2-6 | 1/1 | —CH₂CH₂— | 1 | 80 |
| CTP-20 | 1-22/2-8 | 1/1 | —CH₂CH₂— | 1 | 70 |
| CTP-21 | 1-22/2-14 | 1/1 | —CH₂CH₂— | 1 | 80 |
| CTP-22 | 1-22/2-6 | 1/1 | —CH₂CH₂— | 1 | 50 |

TABLE 16

| | Partial Structure | | | | | |
|---|---|---|---|---|---|---|
| Compound | Structure | Ratio | Y | Z | m | p |
| CTP-23 | 1-6 | — | —CH₂CH₂— | 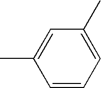 | 1 | 20 |
| CTP-24 | 1-6 | — | —CH₂CH₂— | 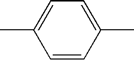 | 2 | 20 |
| CTP-25 | 1-19 | — | —CH₂CH₂— | 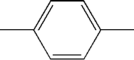 | 1 | 35 |
| CTP-26 | 1-19 | — | —CH₂CH₂— | —CH₂CH₂— | 1 | 45 |
| CTP-27 | 1-19 | — | 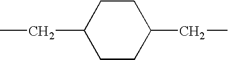 | 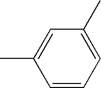 | 1 | 20 |
| CTP-28 | 2-6 | — | —CH₂CH₂— | 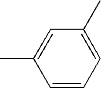 | 1 | 15 |

TABLE 17

| | Partial Structure | | | | |
|---|---|---|---|---|---|
| Compound | Structure | Ratio | Y | n | p |
| CTP-29 | 1-6 | — | O—CH₂CH₂—O— | 1 | 70 |
| CTP-30 | 1-6 | — | O—(CH₂CH₂—O)₂— | 1 | 80 |
| CTP-31 | 1-6 | — | —CH₂CH₂— | 1 | 90 |
| CTP-32 | 1-6 | — | —(CH₂)₈— | 1 | 70 |
| CTP-33 | 1-14 | — | —O—(CH₂CH₂—O)₂— | 1 | 60 |
| CTP-34 | 1-19 | — | — | 0 | 70 |
| CTP-35 | 1-22 | — | — | 0 | 60 |

TABLE 18

| | Partial Structure | | | | | | |
|---|---|---|---|---|---|---|---|
| Compound | Structure | Ratio | Y | m | Z | q | r |
| CTP-36 | 1-6 | — | —CH₂CH₂— | 1 | —(CH₂)₄— | 80 | 40 |
| CTP-37 | 1-6 | — | —CH₂CH₂— | 2 | —(CH₂)₄— | 50 | 10 |
| CTP-38 | 1-6 | — | —CH₂CH₂— | 1 | —(CH₂)₈— | 60 | 30 |
| CTP-39 | 1-6 | — | —CH₂CH₂— | 1 | 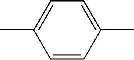 | 70 | 60 |
| CTP-40 | 1-6 | — | —CH₂CH₂— | 1 | 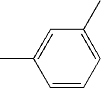 | 80 | 70 |
| CTP-41 | 1-8 | — | —CH₂CH₂— | 1 | —(CH₂)₂— | 100 | 40 |
| CTP-42 | 1-8 | — | —CH₂CH₂— | 1 | —(CH₂)₄— | 80 | 80 |
| CTP-43 | 1-8 | — | —CH₂CH₂— | 2 | —(CH₂)₈— | 40 | 40 |
| CTP-44 | 1-8 | — | —CH₂CH₂— | 1 | 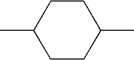 | 40 | 40 |
| CTP-45 | 1-14 | — | —CH₂CH₂CH₂— | 1 | —(CH₂)₄— | 60 | 30 |
| CTP-46 | 1-14 | — | —CH₂CH₂— | 1 | —(CH₂)₈— | 80 | 30 |
| CTP-47 | 1-16 | — | —CH₂CH₂— | 1 | —(CH₂)₂— | 80 | 10 |
| CTP-48 | 1-16 | — | —CH₂CH₂— | 1 | —(CH₂)₁₀— | 100 | 50 |

TABLE 19

| | Partial Structure | | | | | | |
|---|---|---|---|---|---|---|---|
| Compound | Structure | Ratio | Y | m | Z | q | r |
| CTP-49 | 1-19 | — | —CH₂CH₂— | 1 | —(CH₂)₂— | 80 | 30 |
| CTP-50 | 1-19 | — | —CH₂CH₂— | 1 | —(CH₂)₄— | 70 | 50 |
| CTP-51 | 1-19 | — | —CH₂CH₂— | 1 | —(CH₂)₈— | 90 | 80 |
| CTP-52 | 1-19 | — | —CH₂CH₂— | 1 | 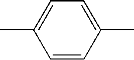 | 60 | 30 |
| CTP-53 | 1-19 | — | —CH₂CH₂— | 1 | 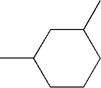 | 70 | 40 |
| CTP-54 | 1-21 | — | —CH₂CH₂— | 1 | —(CH₂)₄— | 100 | 40 |
| CTP-55 | 1-21 | — | —CH₂CH₂— | 2 | —(CH₂)₄— | 60 | 20 |
| CTP-56 | 1-22 | — | —CH₂CH₂— | 1 | —(CH₂)₂— | 100 | 30 |
| CTP-57 | 1-22 | — | —CH₂CH₂— | 1 | —(CH₂)₄— | 90 | 60 |
| CTP-58 | 1-22 | — | —CH₂CH₂— | 1 | —(CH₂)₈— | 70 | 70 |
| CTP-59 | 1-22 | — | —CH₂CH₂— | 1 | 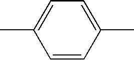 | 70 | 40 |

TABLE 20

| | Partial Structure | | | | | | |
|---|---|---|---|---|---|---|---|
| Compound | Structure | Ratio | Y | m | Z | q | r |
| CTP-60 | 1-22 | — | —CH₂CH₂— | 1 | 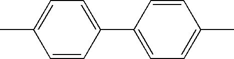 | 80 | 80 |
| CTP-61 | 1-29 | — | —CH₂CH₂— | 2 | —(CH₂)₁₀— | 50 | 30 |
| CTP-62 | 1-30 | — | —CH₂CH₂— | 1 | —(CH₂)₈— | 80 | 40 |
| CTP-63 | 1-31 | — | —CH₂CH₂— | 1 | 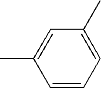 | 60 | 30 |
| CTP-64 | 1-31 | — | —CH₂CH₂— | 1 | —(CH₂)₂— | 80 | 30 |
| CTP-65 | 1-31 | — | —CH₂CH₂— | 1 | —(CH₂)₄— | 90 | 10 |
| CTP-66 | 1-32 | — | —CH₂CH₂— | 1 | —(CH₂)₄— | 80 | 50 |
| CTP-67 | 1-32 | — | —CH₂CH₂— | 1 | —(CH₂)₆— | 70 | 30 |
| CTP-68 | 1-37 | — | —CH₂CH₂— | 1 | —(CH₂)₈— | 60 | 20 |
| CTP-69 | 1-37 | — | —CH₂CH₂— | 3 | —(CH₂)₈— | 35 | 40 |
| CTP-70 | 2-6 | — | —CH₂CH₂CH₂— | 1 | —(CH₂)₈— | 80 | 60 |
| CTP-71 | 2-6 | — | —CH₂CH₂— | 1 | —(CH₂)₆— | 70 | 40 |
| CTP-72 | 2-8 | — | —CH₂CH₂— | 1 | —(CH₂)₄— | 80 | 30 |

TABLE 21

| | Partial Structure | | | | | | |
|---|---|---|---|---|---|---|---|
| Compound | Structure | Ratio | Y | m | Z | q | r |
| CTP-73 | 2-8 | — | —CH₂CH₂— | 2 | —(CH₂)₄— | 85 | 50 |
| CTP-74 | 2-8 | — | —CH₂CH₂— | 1 | —(CH₂)₈— | 100 | 30 |
| CTP-75 | 2-9 | — | —CH₂CH₂— | 1 | —(CH₂)₂— | 90 | 60 |
| CTP-76 | 2-9 | — | —CH₂CH₂— | 1 | —(CH₂)₄— | 80 | 70 |
| CTP-77 | 2-9 | — | —CH₂CH₂— | 1 | —(CH₂)₈— | 50 | 40 |
| CTP-78 | 2-9 | — | —CH₂CH₂— | 1 | 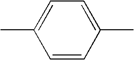 | 80 | 80 |
| CTP-79 | 2-14 | — | —CH₂CH₂— | 2 | —(CH₂)₄— | 40 | 80 |
| CTP-80 | 2-14 | — | —CH₂CH₂— | 1 | —(CH₂)₈— | 80 | 40 |
| CTP-81 | 2-14 | — | | 1 | 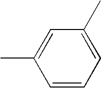 | 60 | 30 |
| CTP-82 | 2-19 | — | —CH₂CH₂— | 1 | —(CH₂)₄— | 80 | 30 |
| CTP-83 | 2-19 | — | —CH₂CH₂— | 1 | —(CH₂)₁₀— | 70 | 10 |
| CTP-84 | 2-29 | — | —CH₂CH₂— | 1 | —(CH₂)₄— | 50 | 50 |
| CTP-85 | 2-29 | — | —CH₂CH₂— | 1 | —(CH₂)₆— | 80 | 10 |

TABLE 22

| | Partial Structure | | | | | | |
|---|---|---|---|---|---|---|---|
| Compound | Structure | Ratio | Y | m | Z | q | r |
| CTP-86 | 2-30 | — | —CH₂CH₂— | 1 | —(CH₂)₈— | 60 | 20 |
| CTP-87 | 2-30 | — | —CH₂CH₂— | 1 | 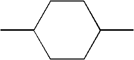 | 80 | 40 |
| CTP-88 | 2-31 | — | —CH₂CH₂CH₂— | 1 | —(CH₂)₄— | 80 | 60 |
| CTP-89 | 2-31 | — | —CH₂CH₂— | 1 | —(CH₂)₈— | 80 | 40 |
| CTP-90 | 2-33 | — | —CH₂CH₂— | 1 | —(CH₂)₄— | 70 | 40 |
| CTP-91 | 2-36 | — | —CH₂CH₂— | 2 | —(CH₂)₄— | 70 | 30 |
| CTP-92 | 2-39 | — | —CH₂CH₂— | 1 | —(CH₂)₈— | 150 | 30 |
| CTP-93 | 2-39 | — | —CH₂CH₂— | 1 | 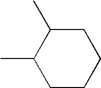 | 90 | 60 |
| CTP-94 | 1-6/1-18 | 1/1 | —CH₂CH₂— | 1 | 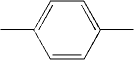 | 110 | 70 |

TABLE 23

| | Partial Structure | | | | | | |
|---|---|---|---|---|---|---|---|
| Compound | Structure | Ratio | Y | m | Z | q | r |
| CTP-95 | 1-6/1-20 | 1/1 | —CH₂CH₂— | 1 | —(CH₂)₂— | 110 | 40 |
| CTP-96 | 1-6/1-20 | 1/1 | —CH₂CH₂— | 1 | —(CH₂)₄— | 85 | 85 |
| CTP-97 | 1-6/2-6 | 1/1 | —CH₂CH₂— | 2 | —(CH₂)₄— | 45 | 30 |
| CTP-98 | 1-19/1-22 | 1/1 | —CH₂CH₂— | 1 | —(CH₂)₈— | 80 | 40 |
| CTP-99 | 1-19/1-26 | 2/1 | | 1 | 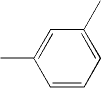 | 60 | 30 |
| CTP-100 | 1-19/1-33 | 1/1 | —CH₂CH₂— | 1 | —(CH₂)₄— | 130 | 30 |
| CTP-101 | 1-19/1-38 | 2/1 | —CH₂CH₂— | 1 | —(CH₂)₁₀— | 130 | 10 |
| CTP-102 | 2-4/2-6 | 1/1 | —CH₂CH₂— | 1 | —(CH₂)₄— | 115 | 50 |
| CTP-103 | 2-5/2-6 | 1/1 | —CH₂CH₂— | 1 | —(CH₂)₆— | 120 | 30 |
| CTP-104 | 2-6/2-19 | 1/1 | | 3 | —(CH₂)₈— | 30 | 20 |
| CTP-105 | 2-19/2-29 | 1/1 | —CH₂CH₂— | 1 | —(CH₂)₈— | 80 | 40 |
| CTP-106 | 2-19/2-22 | 1/1 | —CH₂CH₂CH₂— | 1 | —(CH₂)₆— | 80 | 60 |
| CTP-107 | 2-35/2-31 | 1/1 | —CH₂CH₂— | 1 | —(CH₂)₈— | 110 | 40 |

The polymer charge transport material having a repeating unit that includes a partial structure represented by Formula (X) may be used as a polymer electron transport material.

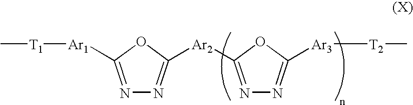

In Formula (X), Ar₁, Ar₂ and Ar₃ each independently represent a substituted or unsubstituted arylene group, a substituted or unsubstituted bivalent heterocyclic group, or a combination of the arylene group and the heterocyclic group; T₁ and T₂ each independently represent a linear or branched bivalent hydrocarbon group having 1 to 10 carbon atoms; and n represents an integer of 0 or 1.

Such a polymer charge transport material may have a single type or two or more types of the structures represented by Formula (X).

In Formula (X), the arylene group represented by Ar₁, Ar₂ or Ar₃ is preferably a monocyclic or condensed ring arylene group having 6 to 60 carbon atoms, more preferably having 6 to 40 carbon atoms, and still more preferably having 6 to 30 carbon atoms.

Examples of the arylene group represented by Ar₁, Ar₂ or Ar₃ include phenylene, biphenylene, triphenylene, tetraphenylene, naphthalendiyl, anthracendiyl, phenanthrolindiyl, pyrendiyl, triphenylendiyl, benzophenanthrolindiyl, perylendiyl, pentaphenylendiyl, and pentacendiyl. Preferred examples include phenylene, biphenylene, naphthalendiyl, anthracendiyl, pyrendiyl, and perylendiyl, and phenylene, biphenylene and triphenylene are particularly preferred.

The bivalent heterocyclic group represented by Ar₁, Ar₂ or Ar₃ is preferably a monocyclic or condensed ring heterocyclic group having 4 to 60 carbon atoms, more preferably a monocyclic or condensed ring heterocyclic group having at least one of nitrogen, oxygen and sulfur atoms and having 4 to 60 carbon atoms, and still more preferably a five- or six-membered heterocyclic group having 4 to 30 carbon atoms.

Examples of the heterocyclic group represented by Ar₁, Ar₂ or Ar₃ include pyrroldiyl, furandiyl, thienylene, pyridindiyl, pyridazindiyl, pyrimidindiyl, pyrazindiyl, quinolindiyl, isoquinolindiyl, cinnolindiyl, quinazolindiyl, quinoxalindiyl, phthalazindiyl, pteridindiyl, acridindiyl, phenazindiyl, and phenanthrolindiyl. Preferred are furandiyl, thienylene, pyridindiyl, pyridazindiyl, pyrimidindiyl, pyrazindiyl, quinolindiyl, quinoxalindiyl, andphthalazindiyl, and more preferred are thienylene and pyridindiyl.

The arylene group, the heterocyclic group or the combination thereof represented by Ar₁, Ar₂ or Ar₃ may each have a substituent(s). Examples of the substituent include alkyl groups (preferably having 1 to 20 carbon atoms, more preferably 1 to 12 carbon atoms, and still more preferably 1 to 8 carbon atoms, such as a methyl group, an ethyl group, an iso-propyl group, a tert-butyl group, a n-octyl group, a n-decyl group, a n-hexadecyl group, a cyclopropyl group, a cyclopentyl group, and a cyclohexyl group), alkenyl groups (preferably having 2 to 20 carbon atoms, more preferably 2 to 12 carbon atoms, and still more preferably 2 to 8 carbon atoms, such as a vinyl group, an allyl group, a 2-butenyl group, and a 3-pentenyl group), alkynyl groups (preferably having 2 to 20 carbon atoms, more preferably 2 to 12 carbon atoms, and still more preferably 2 to 8 carbon atoms, such as a propargyl group and a 3-pentynyl group), aryl groups (preferably having 6 to 30 carbon atoms, more preferably 6 to 20 carbon atoms, and still more preferably 6 to 12 carbon atoms, such as a phenyl group, a p-methylphenyl group and a naphthyl group ), amino groups (preferably having 0 to 20 carbon atoms, more preferably 0 to 10 carbon atoms, and still more preferably 0 to 6 carbon atoms, such as an amino group, a methylamino group, a dimethylamino group, a diethylamino group, and a dibenzylamino group), alkoxy groups (preferably having 1 to 20 carbon atoms, more preferably 1 to 12 carbon atoms, and still more preferably from 1 to 8 carbon atoms, such as a methoxy group, an ethoxy group and a butoxy group), aryloxy groups (preferably having 6 to 20 carbon atoms, more preferably 6 to 16 carbon atoms, and still more preferably 6 to 12 carbon atoms, such as a phenyloxy group and a 2-naphthyloxy group), acyl groups (preferably having 1 to 20 carbon atoms, more preferably 1 to 16 carbon atoms, and still more preferably 1 to 12 carbon atoms, such as an acetyl group, a benzoyl group, a formyl group, and a pivaloyl group), alkoxycarbonyl groups (preferably having 2 to 20 carbon atoms, more preferably 2 to 16 carbon atoms, and still more preferably 2 to 12 carbon atoms, such as a methoxycarbonyl group and an ethoxycarbonyl group), aryloxycarbonyl groups (preferably having 7 to 20 carbon atoms, more preferably 7 to 16 carbon atoms, and still more preferably 7 to 10 carbon atoms, such as a phenyloxycarbonyl group), acyloxy groups (preferably having 2 to 20 carbon atoms, more preferably 2 to 16 carbon atoms, and still more preferably 2 to 10 carbon atoms, such as an acetoxy group and a benzoyloxy group), acylamino groups (preferably having 2 to 20 carbon atoms, more preferably 2 to 16 carbon atoms, and still more preferably 2 to 10 carbon atoms, such as an acetylamino group and a benzoylamino group), alkoxycarbonylamino groups (preferably having 2 to 20 carbon atoms, more preferably 2 to 16 carbon atoms, and still more preferably 2 to 12 carbon atoms, such as a methoxycarbonylamino group), aryloxycarbonylamino groups (preferably having 7 to 20 carbon atoms, more preferably 7 to 16 carbon atoms, and still more preferably 7 to 12 carbon atoms, such as a phenyloxycarbonylamino group), sulfonylamino groups (preferably having 1 to 20 carbon atoms, more preferably 1 to 16 carbon atoms, and still more preferably 1 to 12 carbon atoms, such as a methanesulfonylamino group and a benzenesulfonylamino group), sulfamoyl groups (preferably having 0 to20 carbonatoms, more preferably 0 to 16 carbon atoms, and still more preferably 0 to 12 carbon atoms, such as a sulfamoyl group, a methylsulfamoyl group, a dimethylsulfamoyl group, and a phenylsulfamoyl group), carbamoyl groups (preferably having 1 to 20 carbon atoms, more preferably 1 to 16 carbon atoms, and still more preferably 1 to 12 carbon atoms, such as a carbamoyl group, a methylcarbamoyl group, a diethylcarbamoyl group, and a phenylcarbamoyl group), alkylthio groups (preferably having 1 to 20 carbon atoms, more preferably 1 to 16 carbon atoms, and still more preferably 1 to 12 carbon atoms, such as a methylthio group and an ethylthio group), arylthio groups (preferably having 6 to 20 carbon atoms, more preferably 6 to 16 carbon atoms, and still more preferably 6 to 12 carbon atoms, such as a phenylthio group), sulfonyl groups (preferably having 1 to 20 carbon atoms, more preferably 1 to 16 carbon atoms, and still more preferably 1 to 12 carbon atoms, such as a mesyl group and a tosyl group), sulfinyl groups (preferably having 1 to 20 carbon atoms, more preferably 1 to 16 carbon atoms, and still more preferably 1 to 12 carbon atoms, such as a methanesulfinyl group and a benzenesulfinyl group), ureido groups (preferably having 1 to 20 carbon atoms, more preferably 1 to 16 carbon atoms, and still more preferably 1 to 12 carbon atoms, such as an ureido group, a methylureido group and a phenylureido group), phosphoric acid amide groups (preferably having 1 to 20 carbon atoms, more preferably 1 to 16 carbon atoms, and still more preferably 1 to 12 carbon atoms, such as a diethylphosphoric acid amide group and a phenylphosphoric acid amide group), a hydroxyl group, a mercapto group, halogen atoms (such as a fluorine atom, a chlorine atom, a bromine atom, and an iodine atom), a cyano group, a sulfo group, a carboxyl group, a nitro group, a hydroxamic acid group, a sulfino group, a hydrazino group, an imino group, heterocyclic groups (preferably having 1 to 30 carbon atoms, and more preferably 1 to 12 carbon atoms; examples of the hetero atom including a nitrogen atom, an oxygen atom, and a sulfur atom; and specific examples thereof including an imidazolyl group, a pyridyl group, a quinolyl group, a furyl group, a piperidyl group, a morpholino group, a benzoxazolyl group, a benzimidazolyl group, and a banzothiazolyl group), and silyl groups (preferably having 3 to 40 carbon atoms, more preferably 3 to 30 carbon atoms, and still more preferably 3 to 24 carbon atoms, such as a trimethylsilyl group and a triphenylsilyl group).

These substituents may each have a further substituent. Two or more substituents may be the same or different. If possible, substituents may bond to each other to form a ring(s).

Preferred examples of such a substituent include alkyl groups, alkenyl groups, aralkyl groups, aryl groups, alkoxy groups, aryloxy groups, alkylthio groups, arylthio groups, halogen atoms, a cyano group, and heterocyclic groups; more preferred are alkyl groups, aryl groups, alkoxy groups, aryloxy groups, alkylthio groups, arylthio groups, and heterocyclic groups; and aryl groups and aromatic heterocyclic groups are still more preferred.

In Formula (X), T₁ or T₂ is a linear or branched bivalent hydrocarbon group having 1 to 10 carbon atoms, preferably having 1 to 4 carbon atoms, such as a methylene group, an ethylene group, a propylene group, and a butylene group.

Specific examples of the structure represented by Formula (X) are shown below, but such examples are not intended to limit the scope of the invention.

TABLE 24

| Compound No. | n | Ar1 | Ar2 | Ar3 | T1 | T2 |
|---|---|---|---|---|---|---|
| (1) | O | 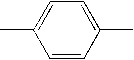 | 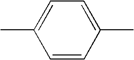 | — | —CH₂— | —CH₂— |
| (2) | O | 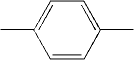 | 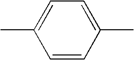 | — | —CH₂CH₂— | —CH₂CH₂— |
| (3) | O | 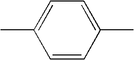 | 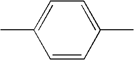 | — | —CH₂CH₂CH₂— | —CH₂CH₂CH₂— |
| (4) | O | 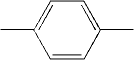 | 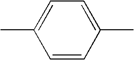 | — | —(CH₂)₄— | —(CH₂)₄— |
| (5) | O | 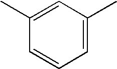 | 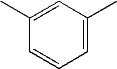 | — | —CH₂— | —CH₂— |
| (6) | O | 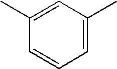 | 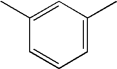 | — | —CH₂CH₂— | —CH₂CH₂— |
| (7) | O | 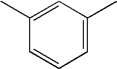 | 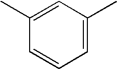 | — | —CH₂CH₂CH₂— | —CH₂CH₂CH₂— |
| (8) | O | 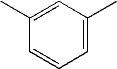 | 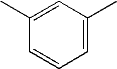 | — | —(CH₂)₄— | —(CH₂)₄— |
| (9) | O | 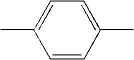 | 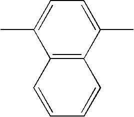 | — | —CH₂— | —CH₂— |

TABLE 25

| Compound No. | n | Ar1 | Ar2 | Ar3 | T1 | T2 |
|---|---|---|---|---|---|---|
| (10) | O | 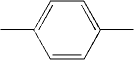 | 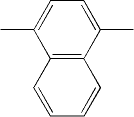 | — | —CH₂CH₂— | —CH₂CH₂— |
| (11) | O | 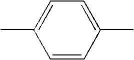 | 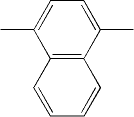 | — | —CH₂CH₂CH₂— | —CH₂CH₂CH₂— |
| (12) | O | 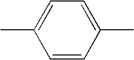 | 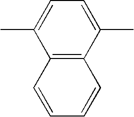 | — | —(CH₂)₄— | —(CH₂)₄— |
| (13) | O | 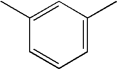 | 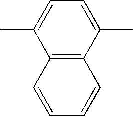 | — | —CH₂— | —CH₂— |
| (14) | O | 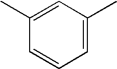 | 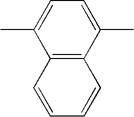 | — | —CH₂CH₂— | —CH₂CH₂— |
| (15) | O | 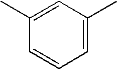 | 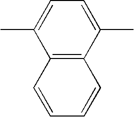 | — | —CH₂CH₂CH₂— | —CH₂CH₂CH₂— |
| (16) | O | 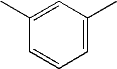 | 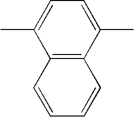 | — | —(CH₂)₄— | —(CH₂)₄— |

TABLE 26

| Compound No. | n | Ar1 | Ar2 | Ar3 | T1 | T2 |
|---|---|---|---|---|---|---|
| (17) | O | 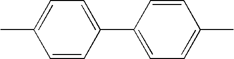 | 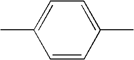 | — | —CH₂— | —CH₂— |
| (18) | O | 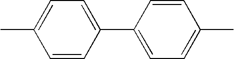 | 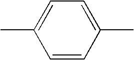 | — | —CH₂CH₂— | —CH₂CH₂— |
| (19) | O | 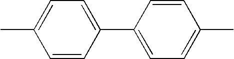 | 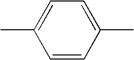 | — | —CH₂CH₂CH₂— | —CH₂CH₂CH₂— |
| (20) | O | 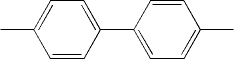 | 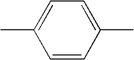 | — | —(CH₂)₄— | —(CH₂)₄— |
| (21) | O | 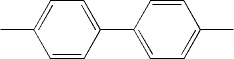 | 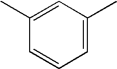 | — | —CH₂— | —CH₂— |
| (22) | O | 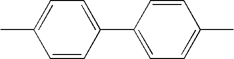 | 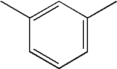 | — | —CH₂CH₂— | —CH₂CH₂— |
| (23) | O | 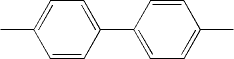 | 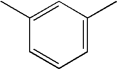 | — | —CH₂CH₂CH₂— | —CH₂CH₂CH₂— |
| (24) | O | 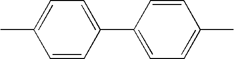 | 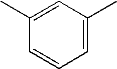 | — | —(CH₂)₄— | —(CH₂)₄— |
| (25) | O | 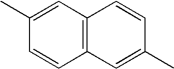 | 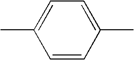 | — | —CH₂— | —CH₂— |

TABLE 27

| Compound No. | n | Ar1 | Ar2 | Ar3 | T1 | T2 |
|---|---|---|---|---|---|---|
| (26) | O | 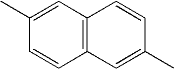 | 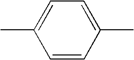 | — | —CH₂CH₂— | —CH₂CH₂— |
| (27) | O | 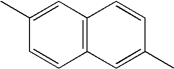 | 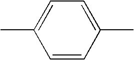 | — | —CH₂CH₂CH₂— | —CH₂CH₂CH₂— |
| (28) | O | 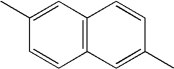 | 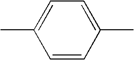 | — | —(CH₂)₄— | —(CH₂)₄— |
| (29) | O | 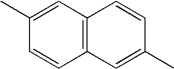 | 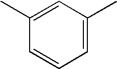 | — | —CH₂— | —CH₂— |
| (30) | O | 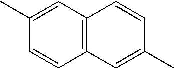 | 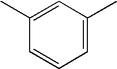 | — | —CH₂CH₂— | —CH₂CH₂— |
| (31) | O | 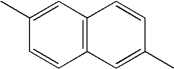 | 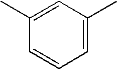 | — | —CH₂CH₂CH₂— | —CH₂CH₂CH₂— |
| (32) | O | 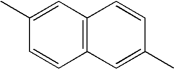 | 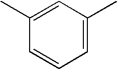 | — | —(CH₂)₄— | —(CH₂)₄— |
| (33) | O | 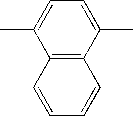 | 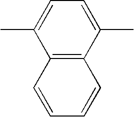 | — | —CH₂— | —CH₂— |
| (34) | O | 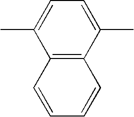 | 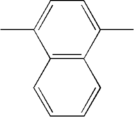 | — | —CH₂CH₂— | —CH₂CH₂— |

TABLE 28

| Compound No. | n | Ar1 | Ar2 | Ar3 | T1 | T2 |
|---|---|---|---|---|---|---|
| (35) | O | 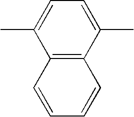 | 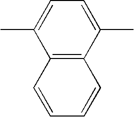 | — | —CH₂CH₂CH₂— | —CH₂CH₂CH₂— |
| (36) | O | 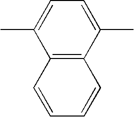 | 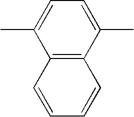 | — | —(CH₂)₄—— | —(CH₂)₄— |
| (37) | O | 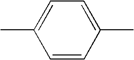 | 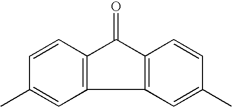 | — | —CH₂— | —CH₂— |
| (38) | O | 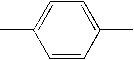 | 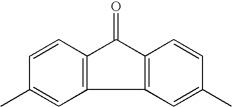 | — | —CH₂CH₂— | —CH₂CH₂— |
| (39) | O | 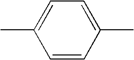 | 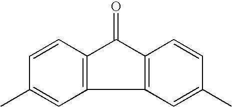 | — | —CH₂CH₂CH₂— | —CH₂CH₂CH₂— |
| (40) | O | 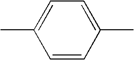 | 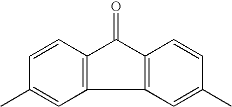 | — | —(CH₂)₄— | —(CH₂)₄— |
| (41) | O | 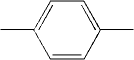 | 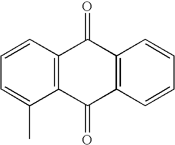 | — | —CH₂— | —CH₂— |

TABLE 29

| Compound No. | n | Ar1 | Ar2 | Ar3 | T1 | T2 |
|---|---|---|---|---|---|---|
| (42) | O | 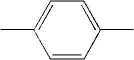 | 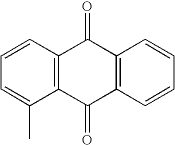 | — | —CH₂CH₂— | —CH₂CH₂— |
| (43) | O | 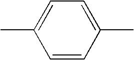 | 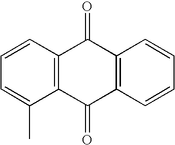 | — | —CH₂CH₂CH₂— | —CH₂CH₂CH₂— |
| (44) | O | 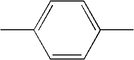 | 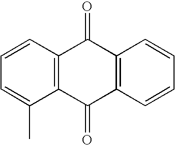 | — | —(CH₂)₄— | —(CH₂)₄— |
| (45) | O | 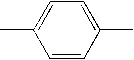 | 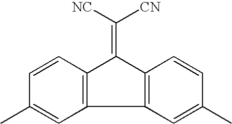 | — | —CH₂— | —CH₂— |
| (46) | O | 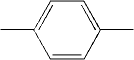 | 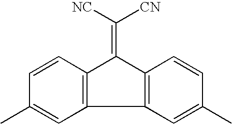 | — | —CH₂CH₂— | —CH₂CH₂— |
| (47) | O | 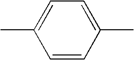 | 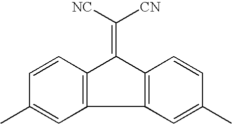 | — | —CH₂CH₂CH₂— | —CH₂CH₂CH₂— |

TABLE 30

| Compound No. | n | Ar1 | Ar2 | Ar3 | T1 | T2 |
|---|---|---|---|---|---|---|
| (48) | O | 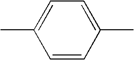 | 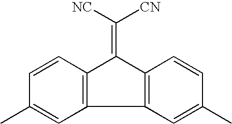 | — | —(CH₂)₄— | —(CH₂)₄— |
| (49) | O | 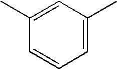 | 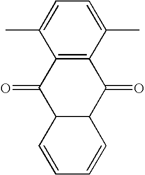 | — | —CH₂— | —CH₂— |
| (50) | O | 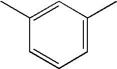 | 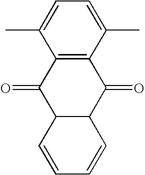 | — | —CH₂CH₂— | —CH₂CH₂— |
| (51) | O | 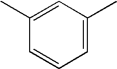 | 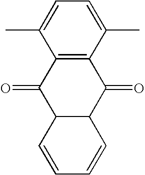 | — | —CH₂CH₂CH₂— | —CH₂CH₂CH₂— |
| (52) | O | 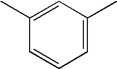 | 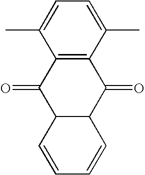 | — | —(CH₂)₄— | —(CH₂)₄— |

TABLE 31

| Compound No. | n | Ar1 | Ar2 | Ar3 | T1 | T2 |
|---|---|---|---|---|---|---|
| (53) | O | 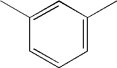 | 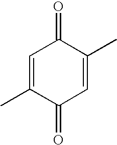 | — | —CH₂— | —CH₂— |
| (54) | O | 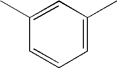 | 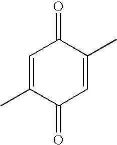 | — | —CH₂CH₂— | —CH₂CH₂— |
| (55) | O | 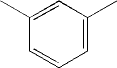 | 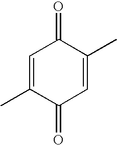 | — | —CH₂CH₂CH₂— | —CH₂CH₂CH₂— |
| (56) | O | 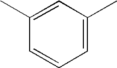 | 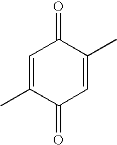 | — | —(CH₂)₄— | —(CH₂)₄— |
| (57) | O | 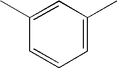 | 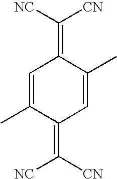 | — | —CH₂— | —CH₂— |

TABLE 32

| Compound No. | n | Ar1 | Ar2 | Ar3 | T1 | T2 |
|---|---|---|---|---|---|---|
| (58) | O | 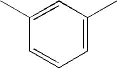 | 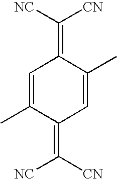 | — | —CH₂CH₂— | —CH₂CH₂— |
| (59) | O | 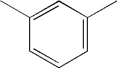 | 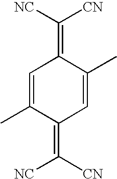 | — | —CH₂CH₂CH₂— | —CH₂CH₂CH₂— |
| (60) | O | 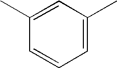 | 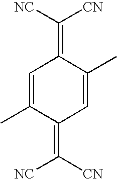 | — | —(CH₂)₄— | —(CH₂)₄— |

TABLE 33

| Compound No. | n | Ar1 | Ar2 | Ar3 | T1 | T2 |
|---|---|---|---|---|---|---|
| (61) | 1 | 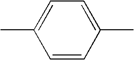 | 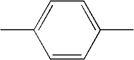 | 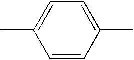 | —CH₂— | —CH₂— |
| (62) | 1 | 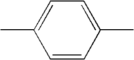 | 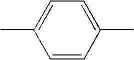 | 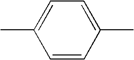 | —CH₂CH₂— | —CH₂CH₂— |
| (63) | 1 | 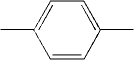 | 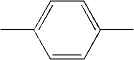 | 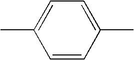 | —CH₂CH₂CH₂ | —CH₂CH₂CH₂— |
| (64) | 1 | 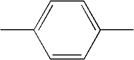 | 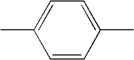 | 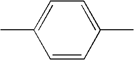 | —(CH₂)₄— | —(CH₂)₄— |
| (65) | 1 | 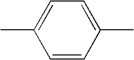 | 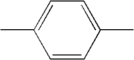 | 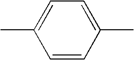 | —CH₂— | —CH₂— |
| (66) | 1 | 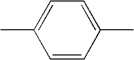 | 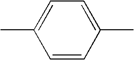 | 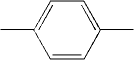 | —CH₂CH₂— | —CH₂CH₂— |
| (67) | 1 | 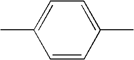 | 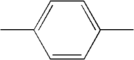 | 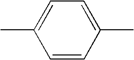 | —CH₂CH₂CH₂ | —CH₂CH₂CH₂— |
| (68) | 1 | 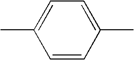 | 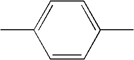 | 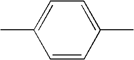 | —(CH₂)₄— | —(CH₂)₄— |
| (69) | 1 | 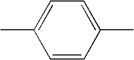 | 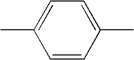 | 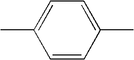 | —CH₂— | —CH₂— |
| (70) | 1 | 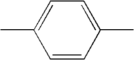 | 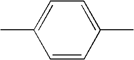 | 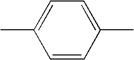 | —CH₂CH₂— | —CH₂CH₂— |

TABLE 34

| Compound No. | n | Ar1 | Ar2 | Ar3 | T1 | T2 |
|---|---|---|---|---|---|---|
| (71) | 1 | 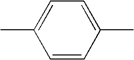 | 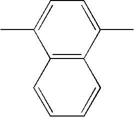 | 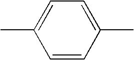 | —CH₂CH₂CH₂— | —CH₂CH₂CH₂— |
| (72) | 1 | 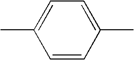 | 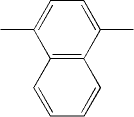 | 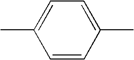 | —(CH₂)₄— | —(CH₂)₄— |
| (73) | 1 | 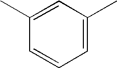 | 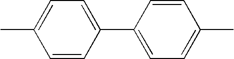 | 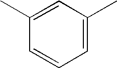 | —CH₂— | —CH₂— |
| (74) | 1 | 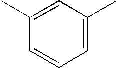 | 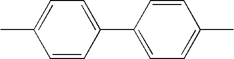 | 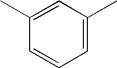 | —CH₂CH₂— | —CH₂CH₂— |
| (75) | 1 | 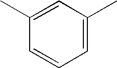 | 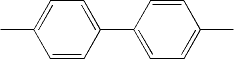 | 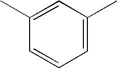 | —CH₂CH₂CH₂— | —CH₂CH₂CH₂— |
| (76) | 1 | 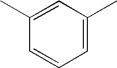 | 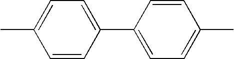 | 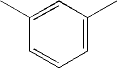 | —(CH₂)₄— | —(CH₂)₄— |
| (77) | 1 | 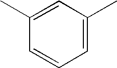 | 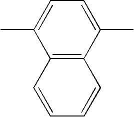 | 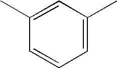 | —CH₂— | —CH₂— |
| (78) | 1 | 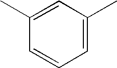 | 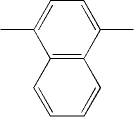 | 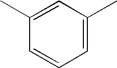 | —CH₂CH₂— | —CH₂CH₂— |
| (79) | 1 | 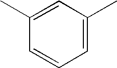 | 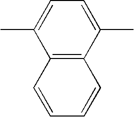 | 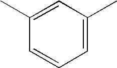 | —CH₂CH₂CH₂— | —CH₂CH₂CH₂— |

TABLE 35

| Compound No. | n | Ar1 | Ar2 | Ar3 | T1 | T2 |
|---|---|---|---|---|---|---|
| (80) | 1 | 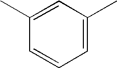 | 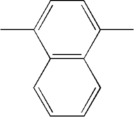 | 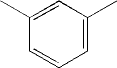 | —(CH₂)₄— | —(CH₂)₄— |
| (81) | 1 | 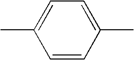 | 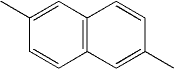 | 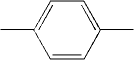 | —CH₂— | —CH₂— |
| (82) | 1 | 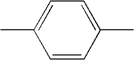 | 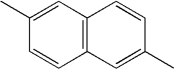 | 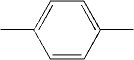 | —CH₂CH₂— | —CH₂CH₂— |
| (83) | 1 | 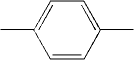 | 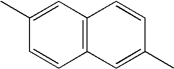 | 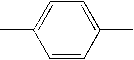 | —CH₂CH₂CH₂— | —CH₂CH₂CH₂— |
| (84) | 1 | 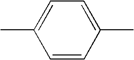 | 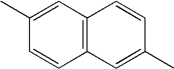 | 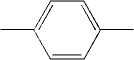 | —(CH₂)₄— | —(CH₂)₄— |
| (85) | 1 | 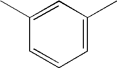 | 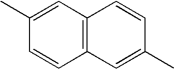 | 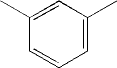 | —CH₂— | —CH₂— |
| (86) | 1 | 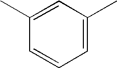 | 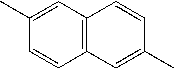 | 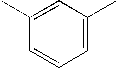 | —CH₂CH₂— | —CH₂CH₂— |
| (87) | 1 | 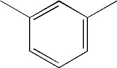 | 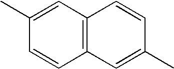 | 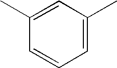 | —CH₂CH₂CH₂— | —CH₂CH₂CH₂— |
| (88) | 1 | 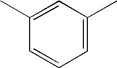 | 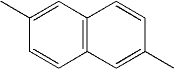 | 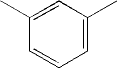 | —(CH₂)₄— | —(CH₂)₄— |

TABLE 36

| Compound No. | n | Ar1 | Ar2 | Ar3 | T1 | T2 |
|---|---|---|---|---|---|---|
| (89) | 1 | 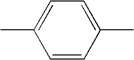 | 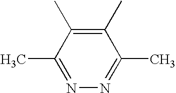 | 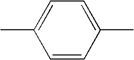 | —CH₂— | —CH₂— |
| (90) | 1 | 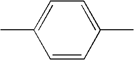 | 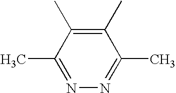 | 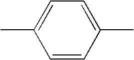 | —CH₂CH₂— | —CH₂CH₂— |
| (91) | 1 | 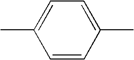 | 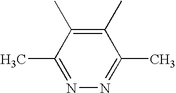 | 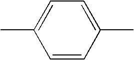 | —CH₂CH₂CH₂— | —CH₂CH₂CH₂— |
| (92) | 1 | 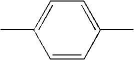 | 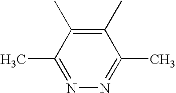 | 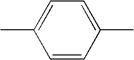 | —(CH₂)₄— | —(CH₂)₄— |
| (93) | 1 | 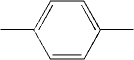 | 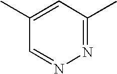 | 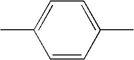 | —CH₂— | —CH₂— |
| (94) | 1 | 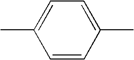 | 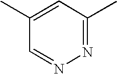 | 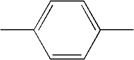 | —CH₂CH₂— | —CH₂CH₂— |
| (95) | 1 | 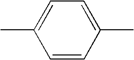 | 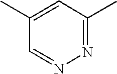 | 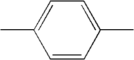 | —CH₂CH₂CH₂— | —CH₂CH₂CH₂— |
| (96) | 1 | 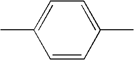 | 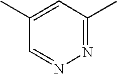 | 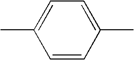 | —(CH₂)₄— | —(CH₂)₄— |

TABLE 37

| Compound No. | n | Ar1 | Ar2 | Ar3 | T1 | T2 |
|---|---|---|---|---|---|---|
| (97) | 1 | 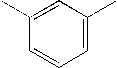 | 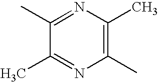 | 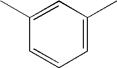 | —CH₂— | —CH₂— |
| (98) | 1 | 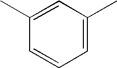 | 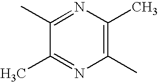 | 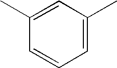 | —CH₂CH₂— | —CH₂CH₂— |
| (99) | 1 | 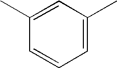 | 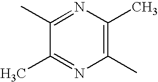 | 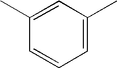 | —CH₂CH₂CH₂— | —CH₂CH₂CH₂— |
| (100) | 1 | 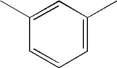 | 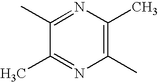 | 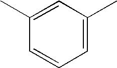 | —(CH₂)₄— | —(CH₂)₄— |
| (101) | 1 | 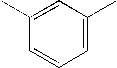 | 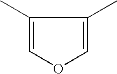 | 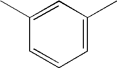 | —CH₂— | —CH₂— |
| (102) | 1 | 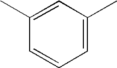 | 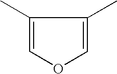 | 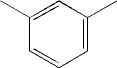 | —CH₂CH₂— | —CH₂CH₂— |
| (103) | 1 | 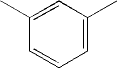 | 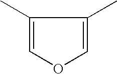 | 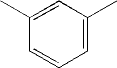 | —CH₂CH₂CH₂— | —CH₂CH₂CH₂— |
| (104) | 1 | 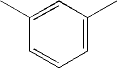 | 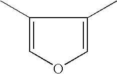 | 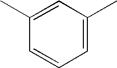 | —(CH₂)₄— | —(CH₂)₄— |

TABLE 38

| Compound No. | n | Ar1 | Ar2 | Ar3 | T1 | T2 |
|---|---|---|---|---|---|---|
| (105) | 1 | 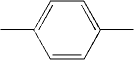 | 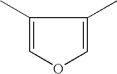 | 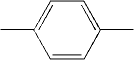 | —CH₂— | —CH₂— |
| (106) | 1 | 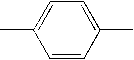 | 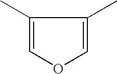 | 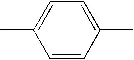 | —CH₂CH₂— | —CH₂CH₂— |
| (107) | 1 | 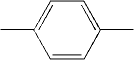 | 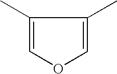 | 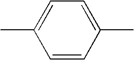 | —CH₂CH₂CH₂— | —CH₂CH₂CH₂— |
| (108) | 1 | 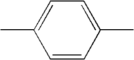 | 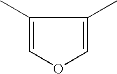 | 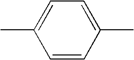 | —(CH₂)₄— | —(CH₂)₄— |
| (109) | 1 | 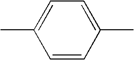 | 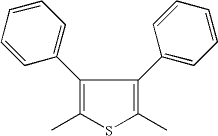 | 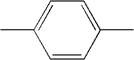 | —CH₂— | —CH₂— |
| (110) | 1 | 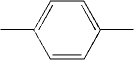 | 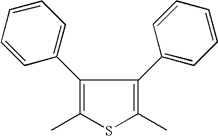 | 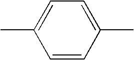 | —CH₂CH₂— | —CH₂CH₂— |

TABLE 39

| Compound No. | n | Ar1 | Ar2 | Ar3 | T1 | T2 |
|---|---|---|---|---|---|---|
| (111) | 1 | 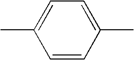 | 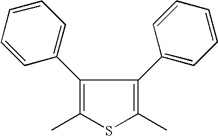 | 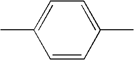 | —CH₂CH₂CH₂— | —CH₂CH₂CH₂— |
| (112) | 1 | 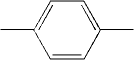 | 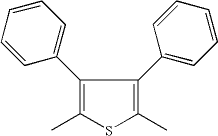 | 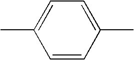 | —(CH₂)₄— | —(CH₂)₄— |
| (113) | 1 | 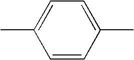 | 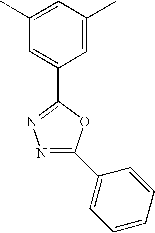 | 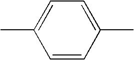 | —CH₂— | —CH₂— |
| (114) | 1 | 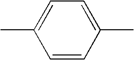 | 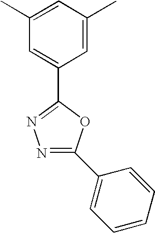 | 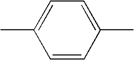 | —CH₂CH₂— | —CH₂CH₂— |

TABLE 40

| Compound No. | n | Ar1 | Ar2 | Ar3 | T1 | T2 |
|---|---|---|---|---|---|---|
| (115) | 1 | 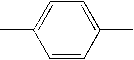 | 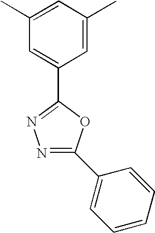 | 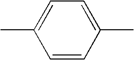 | —CH₂CH₂CH₂— | —CH₂CH₂CH₂— |
| (116) | 1 | 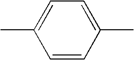 | 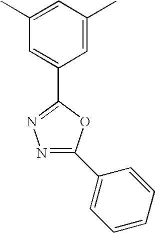 | 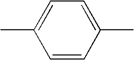 | —(CH₂)₄— | —(CH₂)₄— |
| (117) | 1 | 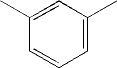 | 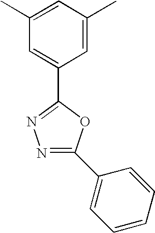 | 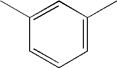 | —CH₂— | —CH₂— |

TABLE 41

| Compound No. | n | Ar1 | Ar2 | Ar3 | T1 | T2 |
|---|---|---|---|---|---|---|
| (118) | 1 | 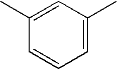 | 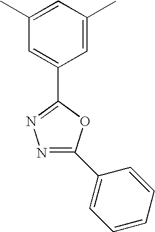 | 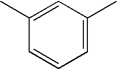 | —CH₂CH₂— | —CH₂CH₂— |
| (119) | 1 | 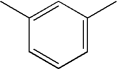 | 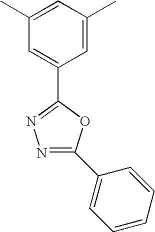 | 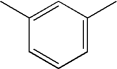 | —CH₂CH₂CH₂— | —CH₂CH₂CH₂— |

According to the invention, the charge transport material satisfies Expressions (1) and (2) in an electric field of 10 V/μm. However, all the above-listed polymer charge transport materials do not always satisfy both Expressions (1) and (2). For example, some of the polymer charge transport materials having the same structure satisfy Expressions (1) and (2), but others do not, depending on their synthesis method and synthesis conditions (such as synthesis temperature and the amount of catalyst).

Next, the layered structure of the inventive organic EL device will be described in detail.

The inventive organic EL device comprises: a pair of electrodes including an anode and a cathode at least one of which is transparent or translucent; and one or more organic compound layers including a light emitting layer and placed between the electrodes.

The inventive organic EL device may have a single organic compound layer. In such a case, the organic compound layer serves as a light emitting layer having a charge transport function. When the device has different organic compound layers, one of them is a light emitting layer, and the remainder includes a hole transport layer or electron transport layer or a hole transport layer and an electron transport layer.

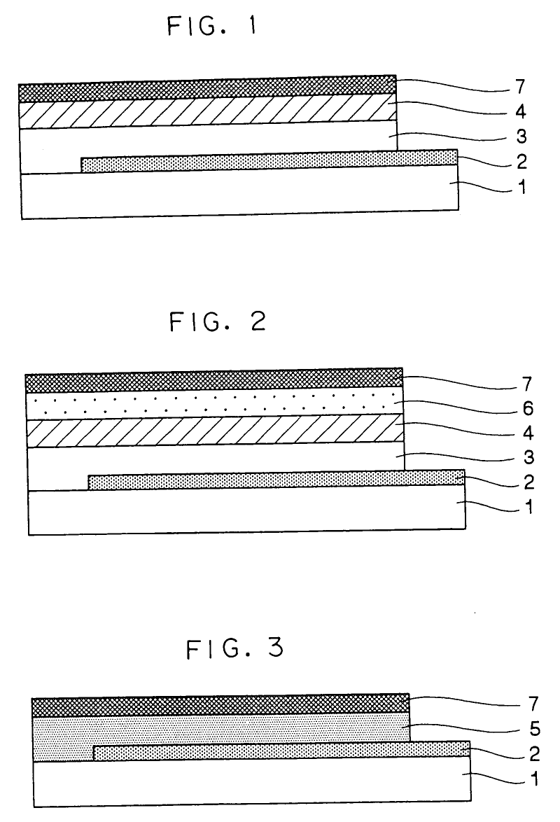

FIGS. 1, 2 and 3 are each a schematic cross section showing a specific layered structure of the inventive organic EL device. FIGS. 1 and 2 show examples each having different organic compound layers, and FIG. 3 shows an example having a single organic compound layer.

In the figures, reference numeral 1 represents a transparent insulation substrate, reference numeral 2 represents a transparent electrode, reference numeral 3 represents a hole transport layer, reference numeral 4 represents a light emitting layer, reference numeral 5 represents a light emitting layer having a charge transport function, reference numeral 6 represents an electron transport layer, and reference numeral 7 represents a backside electrode, respectively.

The transparent insulation substrate 1 is preferably made of a transparent material such as glass and a plastic film, because it is necessary for the substrate 1 to transmit the emitted light.

In order for the transparent electrode 2 to transmit the emitted light, the electrode 2 is preferably made of a transparent material having a high work function for hole injection. Examples of such an electrode material include an oxide film such as an indium tin oxide (ITO) film, a tin oxide (NESA) film, an indium oxide film, and an zinc oxide film, and a vapor-deposited film or a sputtered film of gold, platinum, palladium, or the like.

In the inventive organic EL device, at least one of the organic compound layers contains the charge transport material that satisfies Expressions (1) and (2) in an electric field of 10 V/μm. In the layered structure of the organic EL device shown in FIG. 1 or 2, the charge transport material is contained in the hole transport layer 3 and/or the electron transport layer 6. In the layered structure of the organic EL device shown in FIG. 3, it is contained in the light emitting layer 5 having the charge transport function.

In the light emitting layer 4 or the light emitting layer 5 having the charge transport function as shown in FIGS. 1, 2 or 3, a compound showing a high fluorescence quantum yield in solid state is used as a luminescent material. A low-molecular weight organic compound can be used as the luminescent material provided that a good thin film can be formed by vacuum deposition of it or by application and drying of a solution or dispersion containing it and a binder resin. A polymer charge transport material can also be used as the luminescent material provided that a good thin film can be formed by application and drying of a solution or dispersion containing it.

Examples of the low-molecular weight organic compound include chelate type organometallic complexes, polynuclear or condensed aromatic ring compounds, perylene derivatives, coumarin derivatives, styrylarylene derivatives, silole derivatives, oxazole derivatives, oxathiazole derivatives, and oxadiazole derivatives. Examples of the polymer charge transport material include poly(para-phenylene) derivatives, poly(para-phenylenevinylene) derivatives, polythiophene derivatives, and polyacetylene derivatives. Preferred examples include, but are not limited to, Compounds (VI-1) to (VI-15) shown below.

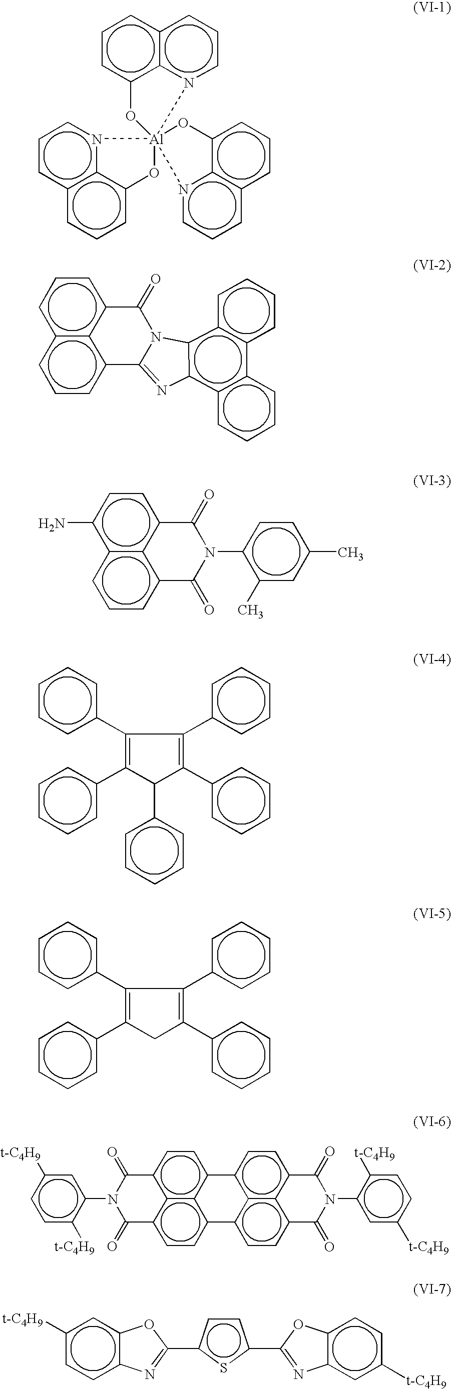

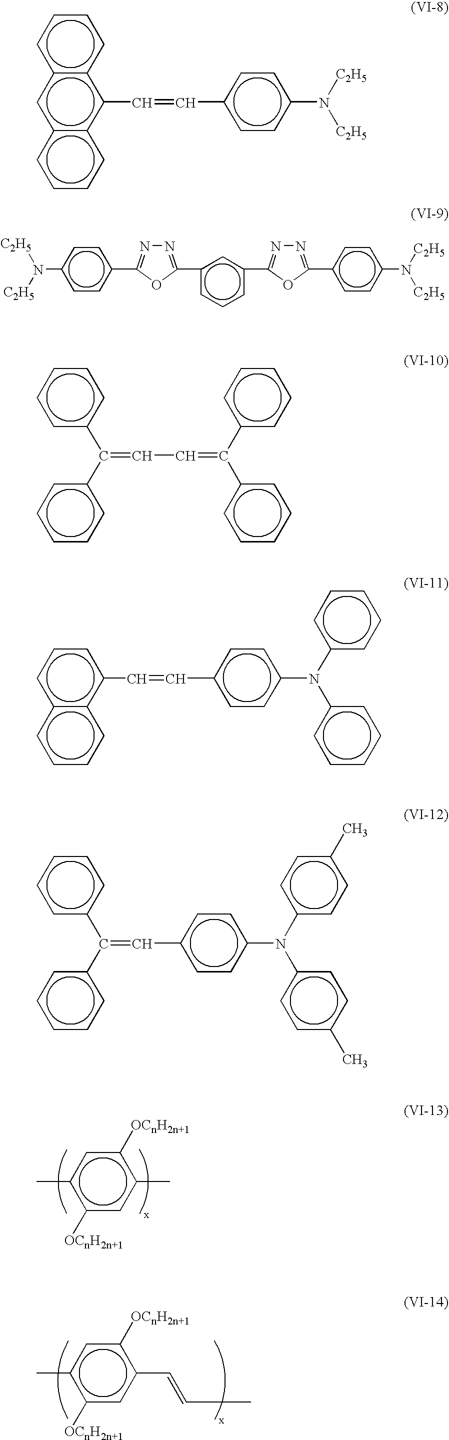

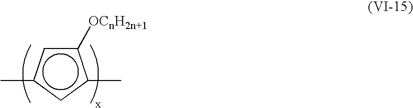

For the purpose of improving the durability or luminous efficiency of the organic EL device, the light emitting layer 4 or the light emitting layer 5 having the charge transport function may be doped with a dye compound as a guest material, which differs from the luminescent material.

The light emitting layer formed by vacuum deposition may be doped by vapor codeposition. When a solution or dispersion is applied and dried to form the light emitting layer, the doping material may be mixed in the solution or dispersion.

The content of the dye compound in the light emitting doped layer is about 0.001% by mass to about 40% by mass, preferably 0.001% by mass to about 10% by mass. The dye component for use in such doping should be an organic compound that has good compatibility with the luminescent material and does not interfere with the proper thin-film formation of the light emitting layer. Preferred examples of such a dye include DCM derivatives, quinacridone derivatives, rubrene derivatives, and porphyrin compounds. Specifically, preferred examples include, but are not limited to, Compounds (VII-1) to (VII-4) shown below.

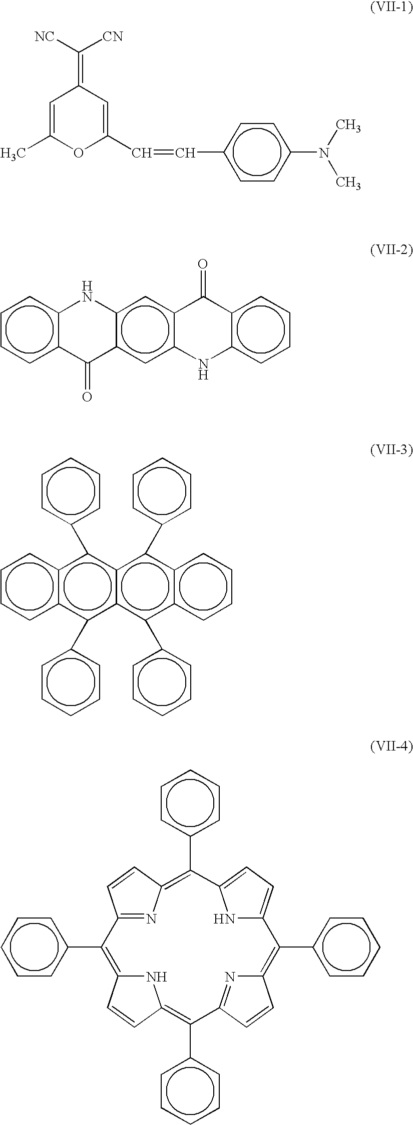

Regarding some luminescent materials, application and drying of the solution or dispersion or vacuum deposition thereof can be performed, but the resulting thin film cannot be of good quality or cannot exhibit clear electron transportability. In such cases, the electron transport layer 6 should preferably be provided between the light emitting layer 4 and the backside electrode 5 for the purpose of improving the durability or luminous efficiency of the organic EL device as shown in FIG. 2. The electron transport material for use in the electron transport layer 6 may be an organic compound capable of forming a good thin film by vacuum deposition. Preferred examples of such a material include oxadiazole derivatives, nitro-substituted fluorenone derivatives, diphenoquinone derivatives, thiopyran dioxide derivatives, and fluorenylidene methane derivatives. Specifically, preferred examples include, but are not limited to, Compounds (VIII-1) to (VIII-3) and (IX) shown below. (VIII-1)

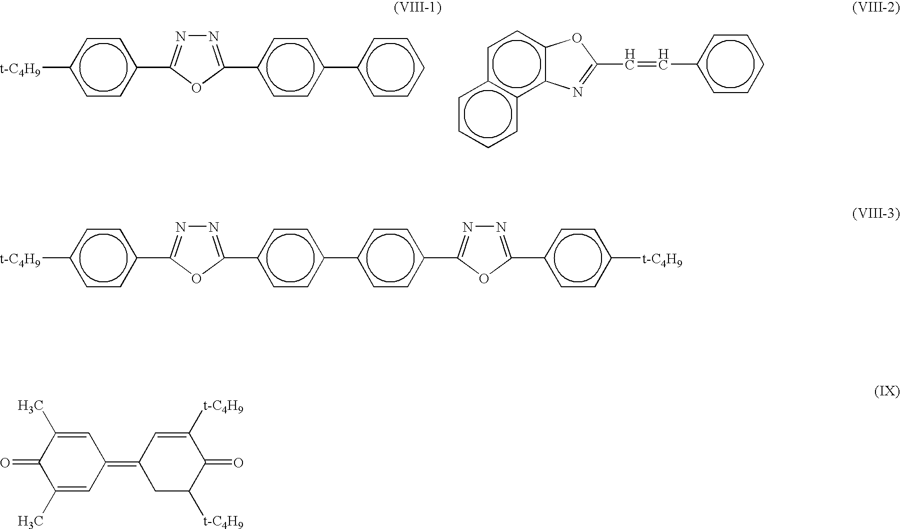

The electron transport layer 6 may also contain the charge transport material satisfying Expressions (1) and (2) in an electric field of 10 V/μm.

### EXAMPLES

The present invention is described in more detail with reference to the following examples, but such examples are not intended to limit the scope of the invention.

### Example 1

A hole transport polymer represented by the following Structural Formula (A) below (Mw=5.0×10⁴) is dissolved in monochlorobenzene to form a 5% by mass solution of the polymer. The solution is filtered through a 0.1 μm polytetrafluoroethylene (PTFE) filter. The resulting solution is applied to an ITO glass substrate by casting to form a hole transport layer with a thickness of 6 μm. After sufficient dying, a gold electrode in a size of 8 mm×8 mm is formed thereon by sputtering, so that a sample for use in TOF measurement is prepared.

An organic EL device is prepared by the following process.

The prepared monochlorobenzene solution is applied by spin coating to a glass substrate with an ITO electrode etched in the shape of a 2 mm wide strip, so that a hole transport layer with a thickness of about 0.1 μm is formed. After sufficient drying, sublimation-purified Compound (VI-1) as illustrated above as a luminescent material is placed in a tungsten boat and vapor-deposited by vacuum deposition to form a light emitting layer with a thickness of 0.05 μm on the hole transport layer. This process is performed at a degree of vacuum of 10⁻⁵ Torr and a boat temperature of 300° C. A Mg—Ag alloy is then deposited by vapor codeposition to form a backside electrode having a width of 2 mm and and a thickness of 0.15 μm and intersecting with the ITO electrode in the plane figure of the resultant. The resulting organic EL device has an effective area of 0.04 cm².

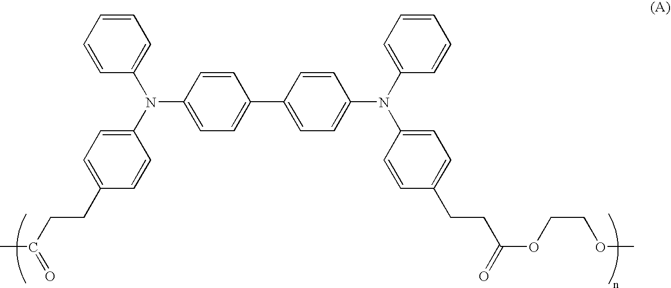

### Example 2

An organic EL device is prepared in the same manner as in Example 1 except that a hole transport polymer represented by the following Structural Formula (B) is used in place of the polymer of Formula (A).

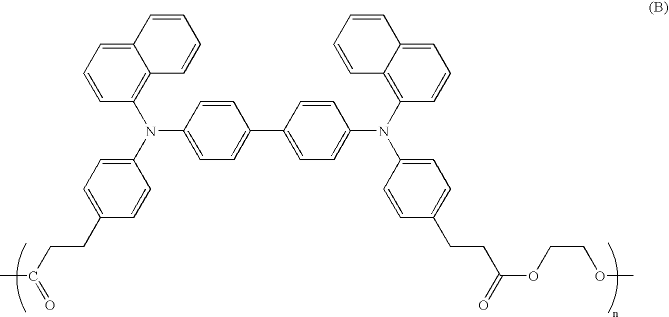

### Example 3

An organic EL device is prepared in the same manner as in Example 1 except that a hole transport polymer represented by the following Structural Formula (C) is used in place of the polymer of Formula (A).

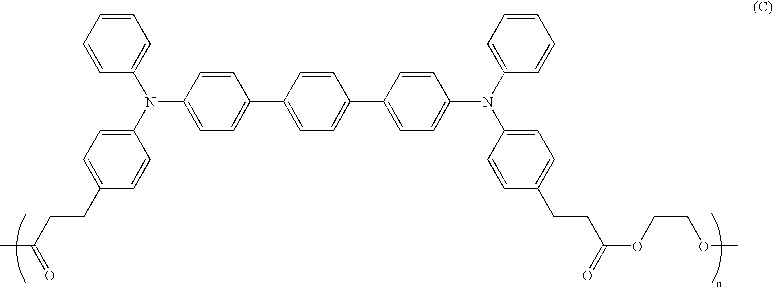

### Example 4

An electron transport polymer represented by the following Structural Formula (D) (Mw=7.0×10⁴) is dissolved in monochlorobenzene to form a 5% by mass solution of the polymer. The solution is filtered through a 0.1 mm polytetrafluoroethylene (PTFE) filter. The resulting solution is applied to an ITO glass substrate by casting to form an electron transport layer with a thickness of 6 μm. After sufficient dying, a gold electrode in a size of 8 mm×8 mm is formed thereon by sputtering, so that a sample for use in TOF measurement is prepared.

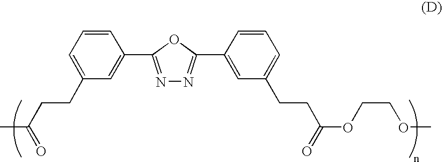

An organic EL device is prepared by the the following process.

A hole transport compound represented by the following Structural Formula (E) is vacuum-deposited on a glass substrate with an ITO electrode etched in the shape of a 2 mm wide strip, so that a hole transport layer with a thickness of about 0.1 μm is formed. Sublimation-purified Compound (VI-1) as illustrated above as a luminescent material is then placed in a tungsten boat and vapor-deposited by vacuum deposition to form a light emitting layer with a thickness of 0.05 μm on the hole transport layer. This process is performed at a degree of vacuum of 10⁻⁵ Torr and a boat temperature of 300° C.

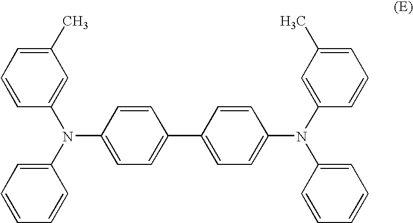

An electron transport polymer represented by Structural Formula (D) is dissolved in toluene to form a 5% by mass solution of the polymer. The solution is filtered through a 0.1 μm polytetrafluoroethylene (PTFE) filter. The toluene solution is then applied to the light emitting layer by spin coating to form an electron transport layer with a thickness about 0.1 μm. A Mg—Ag alloy is then deposited by vapor codeposition to form a backside electrode having a width of 2 mm and a thickness of 0.15 μm and intersecting with the ITO electrode in the plane figure of the resultant. The resulting organic EL device has an effective area of 0.04 cm².

### Comparative Example 1

The hole transport compound represented by Structural Formula (E) is vacuum-deposited on an ITO glass substrate to form a hole transport layer with a thickness of about 6 μm. A gold electrode in a size of 8 mm×8 mm is then formed thereon by sputtering, so that a sample for use in TOF measurement is prepared.

Thereafter, an organic EL device is prepared by the following process.

The hole transport compound represented by Structural Formula (E) is vacuum-deposited on a glass substrate with an ITO electrode etched in the shape of a 2 mm wide strip, so that a hole transport layer with a thickness of about 0.1 μm is formed. Sublimation-purified Compound (VI-1) as illustrated above as a luminescent material is then placed in a tungsten boat and vapor-deposited by vacuum deposition to form a light emitting layer with a thickness of 0.05 μm on the hole transport layer. This process is performed at a degree of vacuum of 10⁻⁵ Torr and a boat temperature of 300° C. A Mg—Ag alloy is then deposited by vapor codeposition to form a backside electrode having a width of 2 mm and a thickness of 0.15 μm and intersecting with the ITO electrode in the plane figure of the resultant. The resulting organic EL device has an effective area of 0.04 cm².

### Comparative Example 2

A compound represented by the following Structural Formula (F) is dissolved in monochlorobenzene to form a 5% by mass solution of the compound. The solution is filtered through a 0.1 μm polytetrafluoroethylene (PTFE) filter. The resulting solution is applied to an ITO glass substrate by casting to form a hole transport layer with a thickness of 6 μm. After sufficient dying, a gold electrode in a size of 8 mm×8 mm is formed thereon by sputtering, so that a sample for use in TOF measurement is prepared.

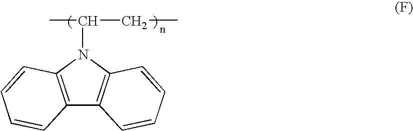

An organic EL device is prepared by the following process.

A monochlorobenzene solution of the compound represented by Structural Formula (F) shown above is applied by dipping to a glass substrate with an ITO electrode etched in the shape of a 2 mm wide strip, so that a hole transport layer with a thickness of about 0.1 μm is formed. After sufficient drying, sublimation-purified Compound (VI-1) as illustrated above as a luminescent material is placed in a tungsten boat and vapor-deposited by vacuum deposition to form a light emitting layer with a thickness of 0.05 μm on the hole transport layer. This process is performed at a degree of vacuum of 10⁻⁵ Torr and a boat temperature of 300° C. A Mg—Ag alloy is then deposited by vapor codeposition to form a backside electrode having a width of 2 mm and a thickness of 0.15 μm and intersecting with the ITO electrode in the plane figure of the resultant. The resulting organic EL device has an effective area of 0.04 cm².

### Comparative Example 3

An electron transport compound represented by the following Structural Formula (G) is vacuum-deposited on an ITO glass substrate to form an electron transport layer with a thickness of about 6 μm. A gold electrode in a size of 8 mm×8 mm is then formed thereon by sputtering, so that a sample for use in TOF measurement is prepared.

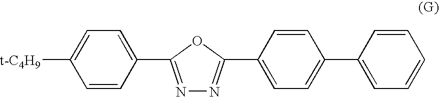

Thereafter, an organic EL device is prepared by the following process.

The hole transport compound represented by Structural Formula (E) is vacuum-deposited on a glass substrate with an ITO electrode etched in the shape of a 2 mm wide strip, so that a hole transport layer with a thickness of about 0.1 μm is formed. Sublimation-purified Compound (VI-1) as illustrated above as a luminescent material is then placed in a tungsten boat and vapor-deposited by vacuum deposition to form a light emitting layer with a thickness of 0.05 μm on the hole transport layer. This process is performed at a degree of vacuum of 10-5 Torr and a boat temperature of 300° C. The electron transport compound represented by Structural Formula (G) is then vacuum-deposited to form an electron transport layer with a thickness of about 0.1 μm on the light emitting layer. A Mg—Ag alloy is then deposited by vapor codeposition to form a backside electrode having a width of 2 mm and a thickness of 0.15 μm and intersecting with the ITO electrode in the plane figure of the resultant. The resulting organic EL device has an effective area of 0.04 cm².

An evaluation is made on each of the TOF measurement devices and the organic EL devices thus prepared.

In vacuum (10⁻³ Torr), an voltage of 10 V/μm is applied to a circuit including the ITO electrode (plus) and the Mg—Ag backside electrode (minus), while a pulse beam is applied from a N₂ laser to the device, so that a transient photocurrent waveform is produced. From the resulting waveform of the charge transport layer, a transit time t_{T}, a current value I_{T} at time t_{T}, a current value Iₐ (half of I_{T}), and a time tₐ at the currrent value Iₐ are obtained, and then whether the obtained values satisfy Expression (1) or not is determined.

In addition, a diffusion coefficient D and a true mobility μ are obtained from the resulting transient photocurrent waveform, and then whether D and μ satisfy Expression (2) or not is determined.

The results are shown in Table 42.

Each organic EL device is also subjected to a light emission measurement in which a DC voltage is applied to a circuit including the ITO electrode (plus) and the Mg—Ag backside electrode (minus) in vacuum (10⁻³ Torr) and the maximum brightness is evaluated. The results are shown in Table 42. Emission life of each organic EL device is also measured in a dry nitrogen atmosphere. In the evaluation of the emission life, the current value is set so as to provide an initial brightness of 50 cd/m², and the time from the start of current flow to a time when the brightness has reduced to half of the initial value under a constant current drive is determined as the life (hours) of the device. These results are also shown in Table 42.

TABLE 42

| | Initial Brightness | Emission Life | | |
|---|---|---|---|---|
| | (cd/m²) | (hour) | (ta-t_{T})/ta | D/μ |
| Example 1 | 1200 | 42 | 0.25 | 12.2 |
| Example 2 | 1500 | 48 | 0.21 | 8.3 |
| Example 3 | 1700 | 50 | 0.20 | 3.5 |
| Example 4 | 1500 | 53 | 0.19 | 4.7 |
| Comparative | 480 | 18 | 0.72 | 27.0 |
| Example 1 | | | | |
| Comparative | 950 | 15 | 0.65 | 35.5 |
| Example 2 | | | | |
| Comparative | 1300 | 22 | 0.60 | 27.2 |
| Example 3 | | | | |

1. An organic electroluminescent device including a pair of electrodes including an anode and a cathode, at least one of which is transparent or translucent; and one or more organic compound layers placed between the pair of electrodes,
wherein at least one of the organic compound layers contains a charge transport material that satisfies the following relations:
(tₐ−t_{T})/tₐ<0.5 Expression (1)
D/μ<20 Expression (2)
wherein, in an electric field of 10 V/μm, t_{T} is a transit time of a transient photocurrent waveform; I_{T} is a current value at time t_{T}; Iₐ is half of the current value I_{T}; tₐ is a time at the current value Iₐ on the transient photocurrent waveform; D and μ are respectively a diffusion coefficient and a true mobility obtained from the transient photocurrent waveform; and D/μ is the ratio of D to μ.

2. An organic electroluminescent device according to claim 1, wherein the charge transport material is a hole transport material.

3. An organic electroluminescent device according to claim 1, wherein the charge transport material is an electron transport material.

4. An organic electroluminescent device according to claim 1, wherein the charge transport material is a polymer charge transport material.

5. An organic electroluminescent device according to claim 4, wherein the polymer charge transport material has a repeating unit that includes a partial structure represented by either one of Formulae (I-1) and (I-2): 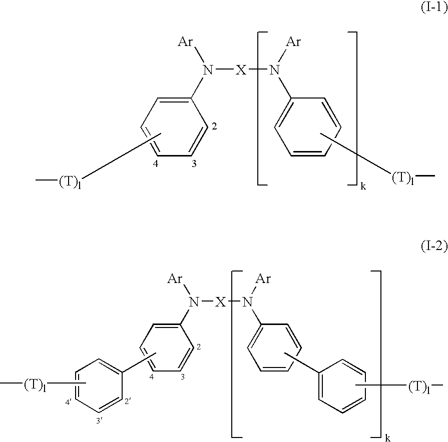
wherein Ar represents a substituted or unsubstituted phenyl group, a substituted or unsubstituted monovalent polynuclear aromatic ring group having 2 to 10 aromatic rings, or a substituted or unsubstituted monovalent condensed aromatic ring group having 2 to 10 aromatic rings; X represents a substituted or unsubstituted bivalent aromatic group; k and 1 each independently represent 0 or 1; and T represents a linear or branched bivalent hydrocarbon group having 1 to 10 carbon atoms.

6. An organic electroluminescent device according to claim 5, wherein the polymer charge transport material is represented by one selected from the group consisting of Formulae (II), (III), (IV) and (V):
CO-A-CO—O—(Y—O)ₘ—ₚ (II)
CO-A-CO—O—(Y—O)ₘ—_{q} CO-Z-CO—O—(Y—O)ₘ—ᵣ (III)
O-A-O—CO—(B—CO)ₙ—ₚ (IV)
CO-A-CO—O—(Y—O)ₘ—_{q} CO-Z-CO—O—(Y—O)ₘ—ᵣ (V)
wherein A represents Formula (I-1) or (I-2); B represents —O—(Y′—O)ₘ, — or Z′; Y, Y′, Z, and Z′ each independently represent a bivalent hydrocarbon group; m and m′ each independently represent an integer from 1 to 5; n represents 0 or 1; p represents an integer from 5 to 5000; q represents an integer from 1 to 5000; and r represents an integer from 1 to 3500.
